(19) United States
(12) Patent Application Publication
(10) Pub. No.: US 2026/0332946 A1
(43) Pub. Date: Oct. 22, 2026

(54) ELECTRONIC DEVICE FOR VEHICLE, AND OPERATING METHOD THEREOF

(71) Applicant: Samsung Electronics Co., Ltd., Suwon-si (KR)

(72) Inventors: Yoonji CHO, Suwon-si (KR); Seungwoo SHIN, Suwon-si (KR); Joonghun KWON, Suwon-si (KR); Hyewon KIM, Suwon-si (KR)

(21) Appl. No.: 19/694,388

(22) Filed: Jun. 1, 2026

Related U.S. Application Data
(63) Continuation of application No. PCT/KR2024/010570, filed on Jul. 22, 2024.

(30) Foreign Application Priority Data
Dec. 1, 2023 (KR) 10-2023-0172769
Jan. 10, 2024 (KR) 10-2024-0004347

(51) Int. Cl. H04R 1/32; G06F 3/16; H04R 1/08; H04R 1/10

(52) U.S. Cl. CPC H04R 1/326; G06F 3/16; H04R 1/08; H04R 1/1016; H04R 2420/01; H04R 2420/07; H04R 2499/13

(57) ABSTRACT

A method of operating an electronic device for a vehicle is provided. The method includes obtaining at least one ambient sound through at least one microphone, identifying, among a plurality of preset groups, a group including the at least one ambient sound, based on at least one of type information and volume information of the at least one ambient sound, and transmitting the at least one ambient sound to a mobile device based on at least one of driving information of a vehicle and surrounding environment information of the vehicle and transmission conditions corresponding to the identified group.

### CROSS-REFERENCE TO RELATED APPLICATION(S)

This application is a continuation application, claiming priority under 35 U.S.C. § 365(c), of an International application No. PCT/KR2024/010570, filed on Jul. 22, 2024, which is based on and claims the benefit of a Korean patent application number 10-2023-0172769, filed on Dec. 1, 2023, in the Ministry of Intellectual Property (MOIP), and of a Korean patent application number 10-2024-0004347, filed on Jan. 10, 2024, in the Ministry of Intellectual Property (MOIP), the disclosure of each of which is incorporated by reference herein in its entirety.

### BACKGROUND

### 1. Field

The disclosure relates to an electronic device for a vehicle and an operating method thereof. More particularly, the disclosure relates to an electronic device for a vehicle and an operating method thereof for providing ambient sound obtained by the electronic device for a vehicle to a user.

### 2. Description of Related Art

As the wearing rate of wearable devices increases, more people tend to wear the wearable devices even while driving a vehicle.

However, when a user wearing a wearable device is consuming media while operating a vehicle, the media is likely to prevent the user from clearly hearing sounds around the vehicle.

A noise canceling function of the wearable device, the vehicle's own sound insulation, or the user's safety gear (e.g., helmets) also prevents the user from clearly hearing the ambient sounds.

Therefore, there is a growing need to provide ambient sounds to vehicle drivers wearing wearable devices based on the vehicle's driving environment and surrounding environment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for a vehicle and an operating method thereof for providing ambient sound obtained by the electronic device for a vehicle to a user.

Additional aspects will be set forth in part in the description which follows and, in part, will be apparent from the description, or may be learned by practice of the presented embodiments.

In accordance with an aspect of the disclosure, an electronic device for a vehicle is provided. The electronic device includes at least one microphone, memory, including one or more storage media, storing instructions, a communicator configured to perform communication with a mobile device, and at least one processor communicatively coupled to the at least one microphone, the memory, and the communicator, wherein the instructions, when executed by the at least one processor individually or collectively, cause the electronic device to obtain at least one ambient sound through the at least one microphone, identify, among a plurality of preset groups, a group including the at least one ambient sound, based on at least one of type information and volume information of the at least one ambient sound, and control the communicator to transmit the at least one ambient sound to the mobile device, based on at least one of driving information of a vehicle and surrounding environment information of the vehicle, and a transmission condition corresponding to the identified group.

In accordance with another aspect of the disclosure, a mobile device is provided. The mobile device includes a communicator configured to perform communication with an electronic device for a vehicle and a wearable device, memory, including one or more storage media, storing instructions, and at least one processor communicatively coupled to the communicator and the memory. The instructions, when executed by the at least one processor individually or collectively, cause the electronic device to control the communicator to receive, from the electronic device for a vehicle, at least one ambient sound or occurrence information of the at least one ambient sound, synthesize the at least one ambient sound or a generated sound corresponding to the occurrence information of the at least one ambient sound with audio data being played, and control the communicator to transmit the synthesized sound to the wearable device.

In accordance with another aspect of the disclosure, a method of operating an electronic device for a vehicle is provided. The method includes obtaining at least one ambient sound through at least one microphone. identifying, among a plurality of preset groups, a group including the at least one ambient sound, based on at least one of type information and volume information of the at least one ambient sound, and transmitting the at least one ambient sound to a mobile device, based on at least one of driving information of a vehicle and surrounding environment information of the vehicle, and a transmission condition corresponding to the identified group.

In accordance with another aspect of the disclosure, a method of a mobile device is provided. The method includes receiving at least one ambient sound or occurrence information of the at least one ambient sound from an electronic device for a vehicle.

In accordance with another aspect of the disclosure, a method of a mobile device is provided. The method includes synthesizing the at least one ambient sound or a generated sound corresponding to the occurrence information of the at least one ambient sound with audio data being played.

In accordance with another aspect of the disclosure, a method of a mobile device is provided. The method includes transmitting the synthesized sound to a wearable device.

In accordance with another aspect of the disclosure, one or more non-transitory computer-readable storage media storing one or more computer programs including computer-executable instructions that, when executed by at least one processor of an electronic device for a vehicle individually or collectively, cause the electronic device to perform operations are provided. The operations include obtaining at least one ambient sound through at least one microphone, identifying, among a plurality of preset groups, a group including the at least one ambient sound, based on at least one of type information and volume information of the at least one ambient sound, and transmitting the at least one ambient sound to a mobile device, based on at least one of driving information of a vehicle and surrounding environment information of the vehicle, and a transmission condition corresponding to the identified group.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates sounds occurring around a vehicle in motion according to an embodiment of the disclosure;

FIG. 1B is a diagram illustrating a connection relationship between an electronic device for a vehicle, a mobile device, and a wearable device, according to an embodiment of the disclosure;

FIG. 2 is a block diagram illustrating components of an electronic device for a vehicle, according to an embodiment of the disclosure;

FIG. 3 is a diagram illustrating a plurality of preset groups according to an embodiment of the disclosure;

FIG. 4 is a diagram illustrating an operation performed by using an artificial intelligence technology, according to an embodiment of the disclosure;

FIG. 5 illustrates an electronic device for a vehicle, which operates in conjunction with a server, according to an embodiment of the disclosure;

FIG. 6 is a diagram illustrating an electronic device FIG. 5 according to an embodiment of the disclosure;

FIG. 7 is a diagram illustrating an embodiment of transmitting an ambient sound from an electronic device for a vehicle to a mobile device according to an embodiment of the disclosure;

FIG. 8 is a diagram illustrating an operation corresponding to transmission of mixing information to a mobile device from an electronic device for a vehicle, according to an embodiment of the disclosure;

FIG. 9 is a block diagram illustrating components of a mobile device, according to an embodiment of the disclosure;

FIG. 10 is a flowchart illustrating a method of operating an electronic device for a vehicle, according to an embodiment of the disclosure;

FIG. 11 is a flowchart illustrating a method of operating an electronic device for a vehicle, according to an embodiment of the disclosure;

FIG. 12 is a flowchart illustrating a method of operating an electronic device for a vehicle, according to an embodiment of the disclosure;

FIG. 13 is a flowchart illustrating a method of operating an electronic device for a vehicle, according to an embodiment of the disclosure;

FIG. 14 is a flowchart illustrating a method of operating a mobile device, according to an embodiment of the disclosure; and

FIG. 15 is a flowchart illustrating a method of operating a mobile device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms are selected as common terms currently widely used, taking into account functions in the disclosure, which may however depend on intentions of ordinary people in the art, judicial precedents, emergence of new technologies, and the like. Some terms as used herein are selected at the applicant's discretion, in which case, the meaning will be explained later in detail in the description of the disclosure. Therefore, the terms should be defined based on their meanings and descriptions throughout the disclosure.

The term “include (or including)” or “comprise (or comprising)” is inclusive or open-ended and does not exclude additional, unrecited elements or method steps. The terms “unit”, “module”, “block”, or the like, as used herein each represent a unit for handling at least one function or operation, and may be implemented in hardware, software, or a combination thereof.

The expression “at least one of A, B and C” refers to one of “A”, “B”, “C”, “A and B”, “A and C”, “B and C”, and “A, B, and C”.

In embodiments of the specification, the term “user” or “passenger” may refer to a person who controls systems, functions or operations.

In embodiments of the specification, the term “vehicle” may refer to a vehicle that includes an electronic device for a vehicle, according to an embodiment.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

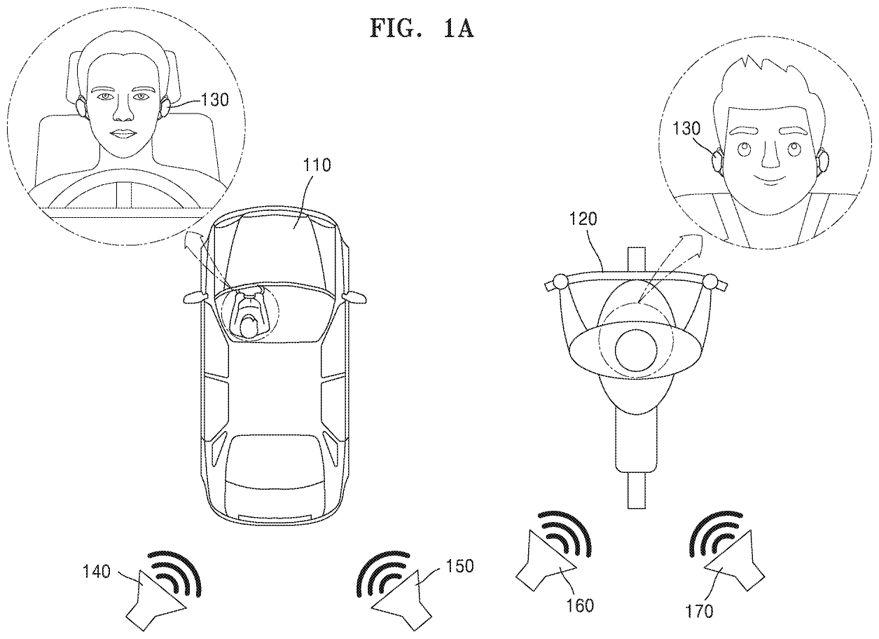

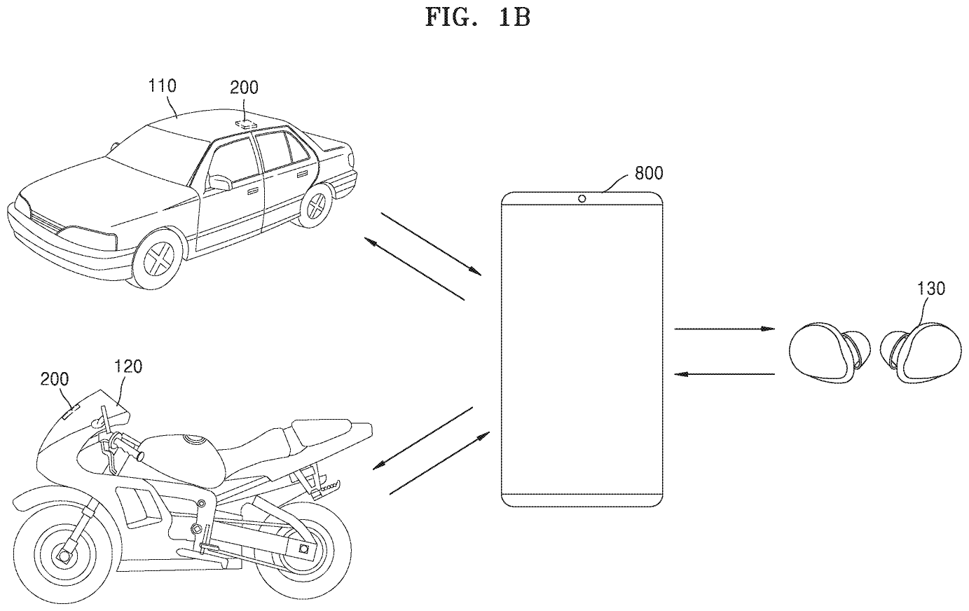

FIG. 1A illustrates sounds occurring around a vehicle in motion according to an embodiment of the disclosure.

Referring to FIG. 1A, in an embodiment of the disclosure, a vehicle including an electronic device for a vehicle may include a four-wheeled vehicle 110 or a two-wheeled vehicle 120. It is not, however, limited thereto, and the vehicle including the electronic device for a vehicle, according to an embodiment may include various types of vehicles.

As the wearing rate of wearable devices increases, there is a growing tendency for people to wear the wearable devices while operating a vehicle.

When a driver operates a vehicle 110 or 120 while wearing a wearable device 130, the driver may fail to perceive ambient sounds 140, 150, 160 and 170 occurring around the vehicle 110 or 120 in motion due to audio data output from the wearable device 130 or due to noise canceling of the wearable device.

To increase driving safety of the vehicle 110 or 120, a method and apparatus for providing the ambient sounds 140, 150, 160 and 170 to the vehicle driver wearing the wearable device 130 based on driving information and a surrounding environment of the vehicle 110 or 120 will now be described.

FIG. 1B is a diagram illustrating a connection relationship between an electronic device for a vehicle, a mobile device, and a wearable device according to an embodiment of the disclosure.

Referring to FIG. 1B, a vehicle including an electronic device 200 for a vehicle, according to an embodiment of the disclosure, may include the four-wheeled vehicle 110 or the two-wheeled vehicle 120. It is not, however, limited thereto, and the vehicle including the electronic device for a vehicle, according to an embodiment of the disclosure, may include various types of vehicles.

The electronic device 200 for a vehicle, according to an embodiment of the disclosure, may be connected to a mobile device 800 according to an embodiment of the disclosure through wireless communication.

The mobile device 800 according to an embodiment of the disclosure may refer to a mobile device of the user including the driver or passenger of the vehicle.

The mobile device 800 according to an embodiment of the disclosure may include a portable electronic device. For example, it may include at least one of the user's smartphone, cell phone or tablet personal computer (tablet PC), or wearable device, but is not limited thereto.

The mobile device 800 according to an embodiment of the disclosure may be connected to the wearable device 130 through wireless communication.

The wireless communication may include at least one short-range communication for performing communication according to a communication standard, such as Bluetooth, Wi-Fi, Bluetooth low energy (BLE), NFC/radio frequency identification (RFID), Wi-Fi direct, ultra-wideband (UWB) or ZIGBEE, and long-range communication for performing communication with a server for supporting the long-range communication according to a long-range communication standard. The long-range communication may be performed over a communication network that conforms to 3^{rd} generation (3G), 4^{th} generation (4G) and/or 5^{th} generation (5G) communication standards, or over a network for Internet communication.

The electronic device 200 for a vehicle, according to an embodiment of the disclosure, the mobile device 800 according to an embodiment of the disclosure and the wearable device are connected to one another through wireless communication, enabling data transmission and reception from the electronic device 200 for a vehicle, according to an embodiment of the disclosure, to the mobile device 800 according to an embodiment of the disclosure, and from the mobile device 800 according to an embodiment of the disclosure to the wearable device 130.

Data transmitted and received among the electronic device 200 for a vehicle 110, according to an embodiment of the disclosure, the mobile device 800 according to an embodiment of the disclosure and the wearable device 130 will now be described in detail.

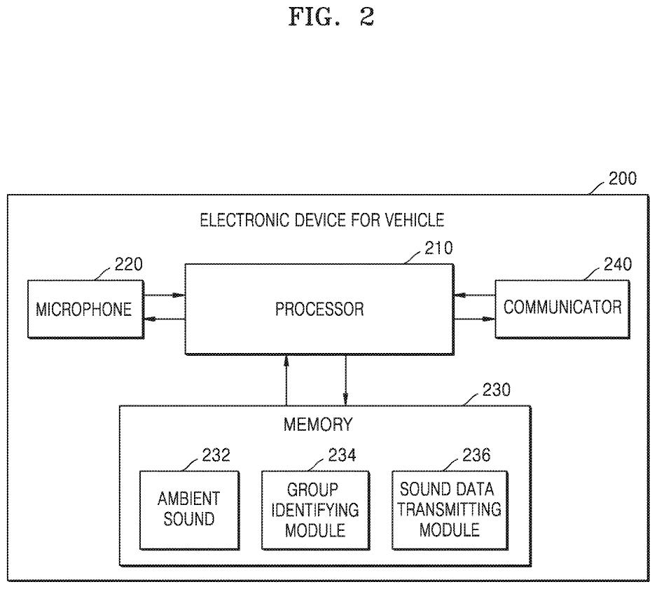

FIG. 2 is a block diagram illustrating components of an electronic device for a vehicle according to an embodiment of the disclosure.

Referring to FIG. 2, the electronic device 200 for a vehicle may include at least one microphone 220, memory 230 that stores at least one instruction, a communicator 240 that performs communication with the mobile device, and at least one processor 210 that executes at least one instruction stored in the memory 230.

The memory 230 may store various data, programs, or applications for driving and controlling the electronic device 200 for a vehicle, according to an embodiment of the disclosure. The memory 230 may include, for example, non-volatile memory including at least one of flash memory, hard disk, multimedia card micro type memory, card type memory (e.g., secure digital (SD) or extreme digital (XD) memory), read-only memory (ROM), electrically erasable programmable ROM (EEPROM), or programmable ROM (PROM), and volatile memory, such as random access memory (RAM) or static RAM (SRAM).

Instructions, data structures, and program codes that are readable by the processor 210 may be stored in the memory 230. In the following embodiments of the disclosure, the processor 210 may be implemented by executing instructions or codes of the program stored in the memory 230.

The programs stored in the memory 230 may be classified into a plurality of modules according to the functions, which may include, for example, an ambient sound obtaining module 232, a group identifying module 234 and a sound data transmitting module 236.

However, the instructions or codes of the program stored in the memory 230 are not limited thereto. For example, the ambient sound obtaining module 232, the group identifying module 234 and the sound data transmitting module 236 are components for an embodiment of the disclosure, and the configurations of the modules included in the memory 230 may be integrated, added or omitted depending on the specification of the electronic device 200 for a vehicle that is actually implemented. In other words, two or more modules may be merged into one, or a single module may be split into two or more modules as needed.

The ambient sound obtaining module 232, the group identifying module 234 and the sound data transmitting module 236 stored in the memory 230 may refer to units of processing functions or operations performed by the processor 210, and may be implemented in software, such as instructions, algorithms, data structures or program codes.

The processor 210 may include hardware components for performing arithmetic, logical, and input/output operations and signal processing. The processor 210 may include at least one of e.g., central processing units (CPUs), microprocessors, graphics processing units (GPUs), application specific integrated circuits (ASIC), digital signal processors (DSPs), digital signal processing devices (DSPDs, programmable logic devices (PLDs), and field programmable gate arrays (FPGAs), without being limited thereto.

The communicator 240 may perform communication with an external device or server over at least one cable or wireless communication network according to the processor 210.

In an embodiment of the disclosure, the communicator 240 may include at least one short-range communication module for performing communication according to a communication standard, such as Bluetooth, Wi-Fi, Bluetooth low energy (BLE), NFC/RFID, Wi-Fi direct, UWB or ZIGBEE, and a long-range communication module for performing communication with a server for supporting the long-range communication according to a long-range communication standard. The long-range communication module may perform communication over a communication network that conforms to 3G, 4G and/or 5G communication standards, or over a network for Internet communication.

The microphone 220 may obtain sounds occurring around the electronic device 200 for a vehicle, according to an embodiment of the disclosure.

The ambient sound obtaining module 232 may be configured with instructions or program codes related to a function and/or operation of obtaining at least one ambient sound through the at least one microphone 220.

In an embodiment of the disclosure, the processor 210 may execute the instructions or program codes of the ambient sound obtaining module 232 to obtain at least one ambient sound through the at least one microphone 220.

In an embodiment of the disclosure, the processor 210 may execute the instructions or program codes of the ambient sound obtaining module 232 to reduce or remove noise when the noise is obtained along with the ambient sound.

In an embodiment of the disclosure, the processor 210 may execute the instructions or program codes of the ambient sound obtaining module 232 to reduce or remove, through a filter, noise obtained along with the ambient sound.

The filter may include, for example, at least one of a band-pass filter, a moving average filter, a finite impulse filter (FIR filter) or an infinite impulse response filter (IIR filter), but is not limited thereto.

In an embodiment of the disclosure, the processor 210 may execute the instructions or program codes of the ambient sound obtaining module 232 to cancel noise obtained along with the at least one ambient sound, based on white noise corresponding to the noise.

In an embodiment of the disclosure, the processor 210 may execute the instructions or program codes of the ambient sound obtaining module 232 to reduce noise obtained along with the at least one ambient sound, based on destructive interference.

The group identifying module 234 may be configured with instructions or program codes related to a function and/or operation of identifying a group that includes the at least one ambient sound among a plurality of preset groups, based on at least one of type information and volume information of the at least one ambient sound.

In an embodiment of the disclosure, the processor 210 may execute the instructions or program codes of the group identifying module 234 to identify a group that includes the at least one ambient sound among a plurality of preset groups, based on at least one of type information and volume information of the at least one ambient sound.

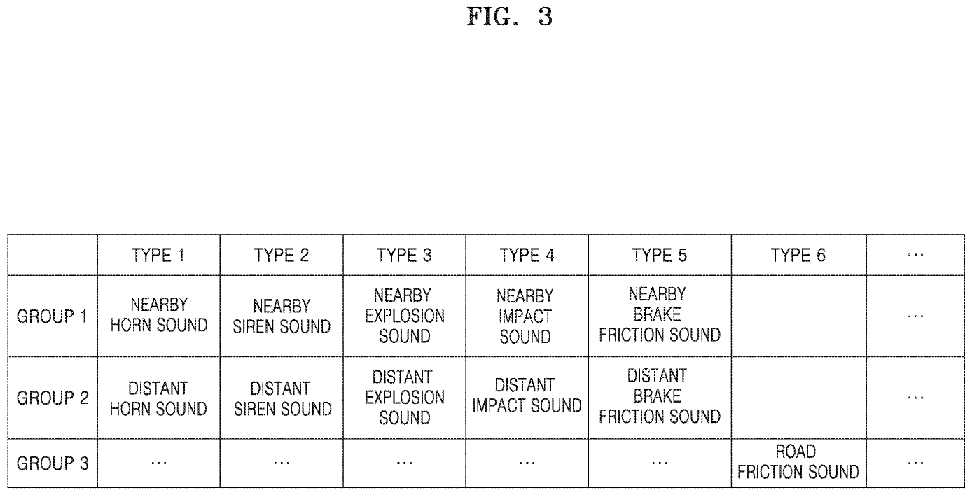

The plurality of preset groups will be described with reference to FIG. 3.

FIG. 3 is a diagram illustrating a plurality of preset groups according to an embodiment of the disclosure.

Referring to FIG. 3, the plurality of preset groups may be classified into group 1, group 2 or group 3 according to the importance of the ambient sounds. However, the number of groups included in the plurality of preset groups is not limited thereto.

The importance may refer to the degree to which the driving of the vehicle is affected.

For example, that the importance of an ambient sound is very high may mean that, when the ambient sound is not perceived, there is a very high possibility of an accident occurring with the vehicle 110 or 120 that includes the electronic device 200 for a vehicle, according to an embodiment of the disclosure.

For example, that the importance of an ambient sound is high may mean that, when the ambient sound is not perceived, there is a high possibility of an accident occurring with the vehicle 110 or 120 that includes the electronic device 200 for a vehicle, according to an embodiment of the disclosure.

For example, that the importance of an ambient sound is low may mean that, when the ambient sound is not perceived, there is a low possibility of an accident occurring with the vehicle 110 or 120 that includes the electronic device 200 for a vehicle, according to an embodiment of the disclosure.

In an embodiment of the disclosure, the processor 210 may execute the instructions or program codes of the group identifying module 234 to add at least one sound with very high importance to group 1.

At least one sound included in group 1 may include at least one of, for example, a short-range horn sound, a short-range siren sound, an explosion sound, an impact sound, or a short-range brake friction sound, but is not limited thereto.

In an embodiment of the disclosure, the processor 210 may execute the instructions or program codes of the group identifying module 234 to add at least one sound with high importance to group 2.

At least one sound included in group 2 may include at least one of, for example, a long-range horn sound, a long-range siren sound, or a long-range brake friction sound, but is not limited thereto.

In an embodiment of the disclosure, the processor 210 may execute the instructions or program codes of the group identifying module 234 to add at least one sound with low importance to group 3.

At least one sound included in group 3 may include at least one of, for example, a road friction sound or a driving sound of an adjacent vehicle, but is not limited thereto.

In an embodiment of the disclosure, the processor 210 may execute the instructions or program codes of the group identifying module 234 to store the at least one sound included in group 1, group 2 or group 3 in the memory 230 for each group.

The at least one sound included in group 1, group 2 or group 3 may be separately changed by the user.

Referring back to FIG. 2, in an embodiment of the disclosure, the processor 210 may execute the instructions or program codes of the group identifying module 234 to identify type information of the at least one ambient sound based on an artificial intelligence model.

Artificial intelligence technology (hereinafter, AI technology) is a technology to obtain a desired result by performing processes, such as analysis and/or classification on input data based on operations through a neural network.

The AI technology may be implemented by using an algorithm. The algorithm or a set of algorithms to implement the AI technology is called the neural network. The neural network may receive input data, and perform an operation for analysis and/or classification to output resulting data. As such, in order for the neural network to output accurate resulting data corresponding to the input data, the neural network needs to be trained. The training may refer to training the neural network to discover or learn by the neural network itself a method of inputting various data to the neural network and analyzing the input data, a method of classifying the input data and/or a method of extracting features required to generate resulting data from the input data. Specifically, through the training procedure, the neural network may be trained with training data (e.g., a plurality of different images) to optimize and set weight values in the neural network. A desired result is then output by learning the input data through the neural network having the optimized weight values.

Specifically, when there are a plurality of hidden layers in the neural network, which perform operations, i.e., when the depth of the neural network for performing the operations increases, the neural network may be classified as a deep neural network (DNN). The neural network may include, for example, a convolutional neural network (CNN), a DNN, a recurrent neural network (RNN), a restricted Boltzmann machine (RBM), a deep belief network (DBN), a bidirectional recurrent deep neural network (BRDNN), and a deep Q-network, without being limited thereto. The neural network may also be subdivided. For example, the CNN neural network may be subdivided into a deep convolution neural network (DCNN) or a Capsnet neural network.

In a disclosed embodiment of the disclosure, an AI model may refer to a neural network including at least one layer that operates to receive input data and output a desired result. Furthermore, the AI model may refer to an algorithm that performs an operation through the neural network to output a desired result, a set of a plurality of algorithms, a processor for executing the algorithm or the set of algorithms, software for executing the algorithm or the set of algorithms or hardware for executing the algorithm or the set of algorithms.

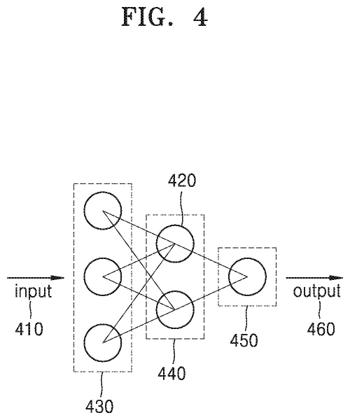

A structure of the neural network will be described with reference to FIG. 4.

FIG. 4 is a diagram van operation performed by using an artificial intelligence technology, according to an embodiment of the disclosure.

Referring to FIG. 4, the operation of identifying type information of at least one ambient sound, which is performed in an embodiment of the disclosure, may be performed by using an AI technology that performs operations through a neural network.

A neural network 420 may be trained by receiving training data. The trained neural network 420 may receive input data 410 through an input end 430, and an output end 450 may analyze the input data 410 and perform an operation to output a desired result as output data 460. An operation through the neural network may be performed through a hidden layer 440. Although the hidden layer 440 is illustrated as being simplified as a single-stage layer in FIG. 4, the hidden layer 440 may be formed of multiple layers.

In an embodiment of the disclosure, the processor 210 may execute instructions or program codes of the group identifying module 234 to train an AI model by using a lossless waveform audio format (wav) for training data.

In an embodiment of the disclosure, the processor 210 may execute the instructions or program codes of the group identifying module 234 to normalize peaks of sound frequency data to extract features of the frequency data.

In an embodiment of the disclosure, the processor 210 may execute the instructions or program codes of the group identifying module 234 to train the AI model based on the features of the frequency data and the training data.

Referring back to FIG. 2, in an embodiment of the disclosure, the processor 210 may execute the instructions or program codes of the group identifying module 234 to identify type information of at least one ambient sound by comparing the at least one ambient sound obtained through the at least one microphone with the training data.

In an embodiment of the disclosure, the processor 210 may execute the instructions or program codes of the ambient sound obtaining module 232 to obtain sounds produced from sound sources located around the vehicle through the at least one microphone.

In an embodiment of the disclosure, the processor 210 may execute the instructions or program codes of the group identifying module 234 to identify type information of the at least one obtained ambient sound by comparing the at least one ambient sound with the training data.

For example, in an embodiment of the disclosure, the processor 210 may execute the instructions or program codes of the ambient sound obtaining module 232 to identify that the obtained sound corresponds to a horn sound by comparing features of the frequency data of the obtained sound with the training data.

In an embodiment of the disclosure, the processor 210 may execute the instructions or program codes of the group identifying module 234 to identify that the obtained sound corresponds to a siren sound by comparing the features of frequency data of the obtained sound with the training data. However, it is not limited thereto.

The AI model may be trained by a server capable of communicating with the electronic device 200 for a vehicle according to an embodiment of the disclosure over a wireless communication network. For example, the external server may train the AI model, and transmit the trained AI model to the electronic device 200 for a vehicle.

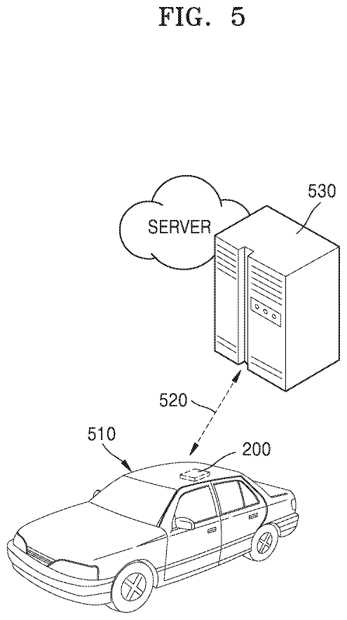

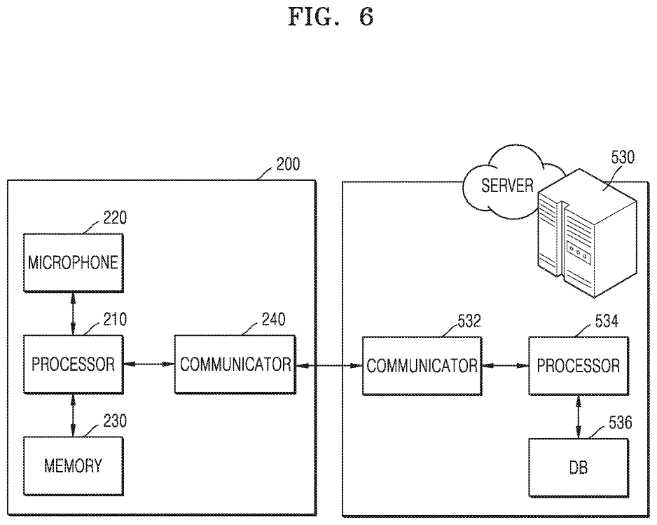

A method by which the server capable of communicating with the electronic device for a vehicle, according to an embodiment of the disclosure, over a wireless communication network trains the AI model will be described with reference to FIGS. 5 and 6.

FIG. 5 illustrates an electronic device for a vehicle, which operates in conjunction with a server according to an embodiment of the disclosure.

Referring to FIG. 5, a server 530 may include a server, a server system, or a server-based device that transmits and receives to and from the electronic device 200 for a vehicle over a communication network 520 and processes the data.

In the disclosed embodiment of the disclosure, the server 530 includes a communicator for communicating with the electronic device 200 for a vehicle installed in a vehicle 510, and a processor for executing at least one instruction.

The server 530 may receive information regarding a criterion for setting filtering data, a type of the filtering data, or the like, from the electronic device 200 for a vehicle or an external device.

The server 530 may train an AI model and store the trained AI model. Furthermore, the server 530 may perform an operation of predicting whether a nearby vehicle will cut in, based on the trained AI model and the received information.

In general, the electronic device 200 for a vehicle has limitations on memory storage capacity, operation processing speed, capability to collect a training data set, or the like, as compared to the server 530. Hence, an operation requiring storage of massive data and a large amount of operation may be performed by the server 530, which may then transmit required data and/or an AI model in use to the electronic device 200 for a vehicle through a communication network. Hence, the electronic device 200 for a vehicle is able to perform a required operation quickly and easily by receiving, through the server, and using the required data and/or AI model, without having a large-capacity memory and a processor having high-speed calculation capability.

FIG. 6 is a diagram illustrating electronic device of FIG. 5 according to an embodiment of the disclosure.

Referring to FIG. 6, the electronic device 200 for a vehicle is described and illustrated by taking the same case as the electronic device 200 for a vehicle as described in FIG. 2 for example.

Referring to FIG. 6, the server 530 may include a communicator 532, a processor 534, and a database (DB) 536.

The communicator 532 may include one or more components that enable communication with the electronic device 200 for a vehicle. The communicator 532 includes at least one communication module, such as a short-range communication module, a wired communication module, a mobile communication module, a broadcast receiving module, or the like. The at least one communication module refers to a communication module that may perform data transmission and reception over a network that conforms to a communication standard, such as a communication scheme using a tuner for performing broadcast reception, Bluetooth, wireless local area network (LAN) (Wi-Fi), wireless broadband (Wibro), world interoperability for microwave access (Wimax), code division multiple access (CDMA), wideband CDMA (WCDMA), Internet, 3G, 4G, 5G and/or 5G, millimeter waves (mmWave).

For example, by performing communication by using the mmWave, the communicator 532 may quickly transmit or receive a large amount of data. Specifically, the vehicle may provide increased safety of the vehicle and/or user convenience by quickly receiving a large amount of data and quickly providing data required for safety of the vehicle (e.g., data required for autonomous driving, data required for a navigation service, or the like), user consumable content (e.g., movie, music, or the like).

Specifically, a mobile communication module included in the communicator 532 may communicate with another device (e.g., a server (not shown)) remotely located through a communication network that conforms to a communication standard, such as 3G, 4G and/or 5G. The communication module that communicates with a server (not shown) remotely located may be referred to as a long-range communication module.

The processor 534 controls general operation of the server 530. For example, the processor 534 may perform required operations by executing at least one of at least one instruction and programs of the server 530.

Furthermore, the DB 536 may include memory (not shown), which may store at least one of at least one instruction, a program, or data required by the server 530 to perform a certain operation. Furthermore, the DB 536 may store data required by the server 530 to perform a neural network based operation.

Specifically, in the disclosed embodiment of the disclosure, the server 530 may store the neural network 420 as described above in FIG. 4. The neural network 420 may be stored in at least one of the processor 534 and the DB 536. The neural network 420 included in the server 530 may be a neural network that has completed learning.

Furthermore, the server 530 may transmit the neural network that has completed learning to the communicator 240 of the electronic device 200 for a vehicle through the communicator 532. The electronic device 200 for a vehicle may then obtain and store the neural network that has completed learning, and obtain desired output data through the neural network.

Referring back to FIG. 2, in an embodiment of the disclosure, the processor 210 may execute the instructions or program codes of the group identifying module 234 to recognize the volume of at least one ambient sound, and obtain volume information indicating the volume of the ambient sound.

In an embodiment of the disclosure, the processor 210 may execute the instructions or program codes of the group identifying module 234 to obtain the volume information of the at least one ambient sound in a decibel (dB) value.

In an embodiment of the disclosure, the processor 210 may execute the instructions or program codes of the group identifying module 234 to predict a distance between the vehicle and at least one sound source based on the volume information of a sound produced from the sound source.

For example, in an embodiment of the disclosure, the processor 210 may execute the instructions or program codes of the group identifying module 234 to identify the sound produced from the at least one sound source as a horn sound. When the volume of the horn sound is identified as being 90 dB or higher, the processor 210 may predict that the distance between the at least one sound source that outputs the horn sound and the vehicle is within a preset distance (short distance).

For example, in an embodiment of the disclosure, the processor 210 may execute the instructions or program codes of the group identifying module 234 to identify the sound produced from the at least one sound source as a siren sound. When the volume of the siren sound is identified as being 90 dB or lower, the processor 210 may predict that the distance between the at least one sound source that outputs the siren sound and the vehicle is equal to or longer than the preset distance (long distance).

For example, in an embodiment of the disclosure, the processor 210 may execute the instructions or program codes of the group identifying module 234 to identify a sound produced from at least one sound source as an explosion sound. When the volume of the explosion sound is identified as being 100 dB or higher, the processor 210 may predict that the distance between the at least one sound source that outputs the explosion sound and the vehicle is within the preset distance (short distance).

For example, in an embodiment of the disclosure, the processor 210 may execute the instructions or program codes of the group identifying module 234 to identify a sound produced from at least one sound source as a brake friction sound. When the volume of the brake friction sound is identified as being 100 dB or higher, the processor 210 may predict that the distance between the at least one sound source that outputs the brake friction sound and the vehicle is within the preset distance (short distance). However, it is not limited thereto.

In an embodiment of the disclosure, the processor 210 may execute the instructions or program codes of the group identifying module 234 to identify a group that includes the at least one ambient sound among a plurality of preset groups, based on at least one of type information of the at least one ambient sound and volume information of the at least one ambient sound.

For example, in an embodiment of the disclosure, the processor 210 may execute the instructions or program codes of the group identifying module 234 to identify the sound produced from the at least one sound source as a horn sound. When the volume of the horn sound is identified as being 90 dB or higher, the processor 210 may identify that the sound produced from the at least one sound source corresponds to a nearby horn sound.

In this case, in an embodiment of the disclosure, the processor 210 may execute the instructions or program codes of the group identifying module 234 to identify that the identified nearby horn sound is included in group 1 with very high importance among the plurality of preset groups.

For example, in an embodiment of the disclosure, the processor 210 may execute the instructions or program codes of the group identifying module 234 to identify a sound produced from at least one sound source as a brake friction sound. When the volume of the brake friction sound is identified as being 90 dB or higher, the processor 210 may identify that the sound produced from the at least one sound source corresponds to a nearby brake friction sound.

In this case, in an embodiment of the disclosure, the processor 210 may execute the instructions or program codes of the group identifying module 234 to identify that the identified nearby brake friction sound is included in group 1 with very high importance among the plurality of preset groups.

For example, in an embodiment of the disclosure, the processor 210 may execute the instructions or program codes of the group identifying module 234 to identify the sound produced from the at least one sound source as a siren sound and identify that the volume of the horn sound is less than 90 dB. For example, in an embodiment of the disclosure, the processor 210 may execute the instructions or program codes of the group identifying module 234 to identify that the sound produced from the at least one sound source corresponds to a distant siren sound.

In this case, in an embodiment of the disclosure, the processor 210 may execute the instructions or program codes of the group identifying module 234 to identify that the identified distant siren sound is included in group 2 with high importance among the plurality of preset groups.

For example, in an embodiment of the disclosure, the processor 210 may execute the instructions or program codes of the group identifying module 234 to identify a sound produced from at least one sound source as a road friction sound. In an embodiment of the disclosure, the processor 210 may execute the instructions or program codes of the group identifying module 234 to identify that the identified road friction sound is included in group 3 with low importance among the plurality of preset groups when the volume of the road friction sound is identified as being less than 50 dB.

The sound data transmitting module 236 may be configured with instructions or program codes related to a function and/or operation of transmitting at least one ambient sound to the mobile device, based on at least one of driving information of the vehicle and surrounding environment information of the vehicle, and a transmission condition corresponding to the identified group.

In an embodiment of the disclosure, the processor 210 may execute the instructions or program codes of the sound data transmitting module 236 to transmit at least one ambient sound to the mobile device.

The driving information of the vehicle may include at least one of speed information of the vehicle or speed change information of the vehicle.

The surrounding environment information of the vehicle may include at least one of location information of at least one sound source that outputs at least one ambient sound, weather information around the vehicle or speed information of an external vehicle located around the vehicle.

In an embodiment of the disclosure, the processor 210 may execute the instructions or program codes of the sound data transmitting module 236 to obtain the surrounding environment information of the vehicle through vehicle to everything (V2X) communication.

The V2X communication refers to communication through which the vehicle may exchange information with infrastructure-equipped objects, such as other vehicles and roads, based on at least one of cable or wireless network.

The V2X communication may include at least one of vehicle to vehicle (V2V) communication, vehicle to infrastructure (V2I) communication, vehicle to network (V2N) communication, or vehicle to pedestrian (V2P) communication.

In an embodiment of the disclosure, the processor 210 may execute the instructions or program codes of the sound data transmitting module 236 to obtain the surrounding environment information of the vehicle through at least one sensor (not shown).

The sensor may include at least one of a global positioning system (GPS) sensor, a sound detection sensor, an image sensor, a camera, Lidar or radar, but is not limited thereto.

In an embodiment of the disclosure, the processor 210 may execute the instructions or program codes of the sound data transmitting module 236 to set a transmission condition for each of the plurality of preset groups.

In an embodiment of the disclosure, the processor 210 may set a sound included in group 1 to be transmitted to the mobile device, regardless of the driving information of the vehicle and the surrounding environment information of the vehicle.

In an embodiment of the disclosure, the processor 210 may identify at least one ambient sound with very high importance as being included in group 1. The processor 210 may transmit the at least one ambient sound to the mobile device regardless of the driving information of the vehicle and the surrounding environment information of the vehicle.

For example, in an embodiment of the disclosure, the processor 210 may identify a sound produced from at least one sound source as a horn sound. The processor 210 may identify that the identified horn sound corresponds to a nearby horn sound, based on the volume information of the horn sound. The processor 210 may identify that the nearby horn sound is included in group 1 of the plurality of preset groups. In an embodiment of the disclosure, the processor 210 may execute the instructions or program codes of the sound data transmitting module 236 to transmit the nearby horn sound to the mobile device, regardless of the driving information of the vehicle (e.g., the vehicle's driving speed).

For example, in an embodiment of the disclosure, the processor 210 may identify a sound produced from at least one sound source as an explosion sound. The processor 210 may identify, based on the volume information of the explosion sound, that the identified explosion sound corresponds to a nearby explosion sound and is included in group 1 of the plurality of preset groups. In an embodiment of the disclosure, the processor 210 may execute the instructions or program codes of the sound data transmitting module 236 to transmit the nearby explosion sound to the mobile device, regardless of the driving information of the vehicle (e.g., vehicle's driving speed). It is not, however, limited thereto.

In an embodiment of the disclosure, the processor 210 may set a transmission condition for transmitting a sound included in group 2 to the mobile device, based on at least one of the driving information of the vehicle and the surrounding environment information of the vehicle.

In an embodiment of the disclosure, the processor 210 may identify at least one ambient sound with high importance as being included in group 2. The processor 210 may transmit the at least one sound included in group 2 to the mobile device, based on at least one of the driving information of the vehicle and the surrounding environment information of the vehicle.

For example, in an embodiment of the disclosure, the processor 210 may identify a sound produced from at least one sound source as a horn sound. The processor 210 may identify, based on the volume information of the horn sound, that the identified horn sound corresponds to a distant horn sound and corresponds to group 2 of the plurality of preset groups. In an embodiment of the disclosure, the processor 210 may execute the instructions or program codes of the sound data transmitting module 236 to transmit the distant horn sound to the mobile device, based on at least one of the speed of the vehicle, location information of a vehicle that produces the horn sound and speed information of the vehicle that produces the horn sound.

For example, in an embodiment of the disclosure, the processor 210 may identify a sound produced from at least one sound source as a brake friction sound. The processor 210 may identify, based on the volume information of the brake friction sound, that the identified brake friction sound corresponds to a distant brake friction sound and corresponds to group 2 of the plurality of preset groups. In an embodiment of the disclosure, the processor 210 may execute the instructions or program codes of the sound data transmitting module 236 to transmit the distant brake friction sound to the mobile device, based on at least one of the speed of the vehicle, weather information around the vehicle or speed information of a vehicle that produces the brake friction sound. However, it is not limited thereto.

In an embodiment of the disclosure, the processor 210 may identify at least one ambient sound with high importance as being included in group 2. The processor 210 may transmit the at least one sound included in group 2 to the mobile device, based on the driving information of the vehicle.

The driving information of the vehicle may include at least one of the speed information of the vehicle or the speed change information of the vehicle.

In an embodiment of the disclosure, the processor 210 may transmit at least one sound included in group 2 to the mobile device, based on the speed information of the vehicle that includes the electronic device 200 for vehicle.

For example, the processor 210 may identify a sound produced from at least one sound source as a brake friction sound. In an embodiment of the disclosure, the processor 210 may identify, based on the volume information of the brake friction sound, that the identified brake friction sound corresponds to a distant brake friction sound and corresponds to group 2 of the plurality of preset groups. In an embodiment of the disclosure, the processor 210 may transmit the distant brake friction sound to the mobile device, when the vehicle that includes the electronic device 200 for vehicle is driving at high speed.

High-speed driving may refer to a case that the vehicle including the electronic device 200 for vehicle according to an embodiment of the disclosure is driving at or above a certain speed.

The certain speed may be set based on speed limits of the road on which the vehicle including the electronic device 200 for vehicle according to an embodiment of the disclosure is driving. However, it is not limited thereto.

In an embodiment of the disclosure, the processor 210 may obtain information about speed limits of the road on which the vehicle including the electronic device 200 for vehicle is driving, through V2X communication.

For example, in an embodiment of the disclosure, the processor 210 may set the certain speed to 30 km/h, when the vehicle including the electronic device 200 for vehicle is driving on a road with a speed limit of 30 km/h.

For example, in an embodiment of the disclosure, the processor 210 may set the certain speed to 100 km/h, when the vehicle including the electronic device 200 for vehicle is driving on a road with a speed limit of 100 km/h. However, it is not limited thereto.

The certain speed may be changed by the user.

For example, the user may set the certain speed to 80 km/h regardless of the speed limits of the road on which the vehicle including the electronic device 200 for vehicle according to an embodiment of the disclosure is driving.

For example, the user may set the certain speed to 100 km/h regardless of the speed limits of the road on which the vehicle including the electronic device 200 for vehicle 110 according to an embodiment of the disclosure is driving. However, it is not limited thereto.

In an embodiment of the disclosure, the processor 210 may transmit at least one sound included in group 2 to the mobile device, based on speed change information of the vehicle including the electronic device 200 for vehicle.

The speed change information of the vehicle may include at least one of sudden acceleration or sudden deceleration.

Sudden acceleration may refer to a sudden increase in speed of the vehicle including the electronic device 200 for vehicle according to an embodiment of the disclosure in a short period of time.

For example, sudden acceleration may refer to an increase in speed of the vehicle including the electronic device 200 for vehicle according to an embodiment of the disclosure by a speed of 2.8 m/s or more, but is not limited thereto.

Sudden deceleration may refer to a sudden decrease in speed of the vehicle including the electronic device 200 for vehicle according to an embodiment of the disclosure in a short period of time.

For example, sudden deceleration may refer to a decrease in speed of the vehicle including the electronic device 200 for vehicle according to an embodiment of the disclosure by a speed of 2.8 m/s or more, but is not limited thereto.

For example, the processor 210 may identify a sound produced from at least one sound source as a brake friction sound. In an embodiment of the disclosure, the processor 210 may identify, based on the volume information of the brake friction sound, that the identified brake friction sound corresponds to a distant brake friction sound and corresponds to group 2 of the plurality of preset groups. In an embodiment of the disclosure, the processor 210 may not transmit the distant brake friction sound to the mobile device, when the vehicle including the electronic device 200 for vehicle is driving at low speed.

In an embodiment of the disclosure, the processor 210 may transmit the distant brake friction sound to the mobile device, when the vehicle including the electronic device 200 for vehicle accelerates rapidly. The distant brake friction sound may refer to a brake friction sound produced from a sound source located in a direction in which the vehicle including the electronic device 200 for vehicle accelerates rapidly. However, it is not limited thereto.

For example, the processor 210 may identify a sound produced from at least one sound source as a horn sound. In an embodiment of the disclosure, the processor 210 may identify, based on the volume information of the horn sound, that the identified horn sound corresponds to a distant horn sound and corresponds to group 2 of the plurality of preset groups. In an embodiment of the disclosure, the processor 210 may not transmit the distant horn sound to the mobile device, when the vehicle including the electronic device 200 for vehicle is driving at low speed. However, it is not limited thereto.

In an embodiment of the disclosure, the processor 210 may transmit the distant horn sound to the mobile device, when the vehicle including the electronic device 200 for vehicle decelerates rapidly. The distant horn sound may refer to a brake friction sound produced from a sound source located behind the vehicle including the electronic device 200 for vehicle according to an embodiment of the disclosure. However, it is not limited thereto.

Low-speed driving may refer to a case that the vehicle including the electronic device 200 for vehicle according to an embodiment of the disclosure is driving at less than a certain speed.

The certain speed may be set based on speed limits of the road on which the vehicle including the electronic device 200 for vehicle according to an embodiment of the disclosure is driving. However, it is not limited thereto.

In an embodiment of the disclosure, the processor 210 may obtain information about speed limits of the road on which the vehicle including the electronic device 200 for vehicle is driving, through V2X communication. However, it is not limited thereto.

For example, in an embodiment of the disclosure, the processor 210 may set the certain speed of the vehicle to 30 km/h, when the vehicle including the electronic device 200 for vehicle is driving on a road with a speed limit of 30 km/h.

For example, in an embodiment of the disclosure, the processor 210 may set the certain speed of the vehicle to 80 km/h, when the vehicle including the electronic device 200 for vehicle is driving on a road with a speed limit of 80 km/h. However, it is not limited thereto.

The certain speed may be changed by the user.

For example, the user may set the certain speed of the vehicle to 50 km/h regardless of the speed limits of the road on which the vehicle including the electronic device 200 for vehicle according to an embodiment of the disclosure is driving.

For example, the user may set the certain speed of the vehicle to 100 km/h regardless of the speed limits of the road on which the vehicle including the electronic device 200 for vehicle according to an embodiment of the disclosure is driving.

In an embodiment of the disclosure, the processor 210 may identify at least one ambient sound with high importance as being included in group 2. The processor 210 may transmit the at least one sound included in group 2 to the mobile device, based on the surrounding environment information.

The surrounding environment information of the vehicle may include at least one of location information of at least one sound source that outputs at least one ambient sound, weather information around the vehicle or speed information of an external vehicle located around the vehicle. However, it is not limited thereto.

In an embodiment of the disclosure, the processor 210 may identify a sound produced from at least one sound source as a rain sound.

In an embodiment of the disclosure, the processor 210 may obtain precipitation information based on the volume information of the rain sound.

In an embodiment of the disclosure, the processor 210 may transmit at least one sound included in group 2 to the mobile device, based on the precipitation information.

For example, the processor 210 may identify a sound produced from at least one sound source as a brake friction sound. In an embodiment of the disclosure, the processor 210 may identify, based on the volume information of the brake friction sound, that the identified brake friction sound corresponds to a distant brake friction sound and corresponds to group 2 of the plurality of preset groups. In an embodiment of the disclosure, the processor 210 may transmit the distant brake friction sound to the mobile device, when the amount of precipitation is equal to or greater than a set value.

For example, the processor 210 may identify a sound produced from at least one sound source as a siren sound. In an embodiment of the disclosure, the processor 210 may identify, based on the volume information of the siren sound, that the identified siren sound corresponds to a distant siren sound and corresponds to group 2 of the plurality of preset groups. In an embodiment of the disclosure, the processor 210 may transmit the distant siren sound to the mobile device, when the amount of precipitation is equal to or greater than a set value.

The set value may be 15 mm, but is not limited thereto.

The set value may be changed by the user.

In an embodiment of the disclosure, the processor 210 may obtain surrounding environment information of the vehicle through a sensor.

The surrounding environment information may include brightness information of a road on which the vehicle including the electronic device 200 for vehicle according to an embodiment of the disclosure is driving.

In an embodiment of the disclosure, the processor 210 may obtain the brightness information of the road in a lux value.

In an embodiment of the disclosure, the processor 210 may transmit at least one sound included in group 2 to the mobile device, based on the brightness information of the road on which the vehicle is driving.

For example, the processor 210 may identify a sound produced from at least one sound source as a siren sound. In an embodiment of the disclosure, the processor 210 may identify, based on the volume information of the siren sound, that the identified siren sound corresponds to a distant siren sound and corresponds to group 2 of the plurality of preset groups. In an embodiment of the disclosure, the processor 210 may transmit the distant siren sound to the mobile device, when the brightness of the road on which the vehicle that includes the electronic device 200 for vehicle according to an embodiment of the disclosure is driving is equal to or less than a threshold.

For example, in an embodiment of the disclosure, the processor 210 may transmit the distant siren sound to the mobile device when the brightness of light obtained through the sensor is equal to or less than 50 lux. However, it is not limited thereto.

The threshold may be changed by the user.

In an embodiment of the disclosure, the processor 210 may set a transmission condition for transmitting a sound included in group 3 to the mobile device, based on the surrounding environment information of the vehicle.

In an embodiment of the disclosure, the processor 210 may identify at least one sound with low importance as being included in group 3. The processor 210 may transmit the at least one sound included in group 3 to the mobile device, based on the surrounding environment information of the vehicle.

For example, in an embodiment of the disclosure, the processor 210 may identify a sound produced from at least one sound source as a road friction sound. The processor 210 may identify, based on the volume information of the road friction sound, that the identified road friction sound corresponds to group 3 of the plurality of preset groups. In an embodiment of the disclosure, the processor 210 may execute the instructions or program codes of the sound data transmitting module 236 to transmit the road friction sound to the mobile device, based on location information of a plurality of external vehicles located around the vehicle and approach information of the plurality of external vehicles toward the vehicle. However, it is not limited thereto.

The aforementioned transmission condition for each of the plurality of preset groups is merely an example and is not limited thereto.

The transmission condition for each of the plurality of preset groups may be changed by the user.

The transmission condition for each of the plurality of preset groups may be stored in the memory 230 of the electronic device 200 for vehicle according to an embodiment of the disclosure.

In an embodiment of the disclosure, the processor 210 may execute the instructions or program codes of the sound data transmitting module 236 to transmit occurrence information of at least one ambient sound to the mobile device.

The occurrence information of the at least one ambient sound may include information indicating that at least one ambient sound has occurred.

For example, the occurrence information of the at least one ambient sound may include information indicating that a nearby horn sound has occurred, when the processor 210 according to an embodiment of the disclosure recognizes the nearby horn sound.

For example, the occurrence information of the at least one ambient sound may include information indicating that a distant siren sound has occurred, when the processor 210 according to an embodiment of the disclosure recognizes the distant siren sound. However, it is not limited thereto.

Upon receiving the occurrence information of the at least one ambient sound, the mobile device may transmit a generated sound corresponding to the occurrence information of the at least one ambient sound to the wearable device.

The generated sound corresponding to the occurrence information of the at least one ambient sound may refer to a sound produced by the mobile device based on an artificial intelligence model.

The generated sound corresponding to the occurrence information of the at least one ambient sound may refer to a sound stored in memory of the mobile device.

When latency occurs in transmitting the at least one ambient sound to the mobile device from the electronic device 200 for vehicle according to an embodiment of the disclosure, the mobile device may transmit a generated sound corresponding to the occurrence information of the at least one ambient sound to the wearable device.

In a case that latency occurs when the mobile device receives the at least one ambient sound from the electronic device for vehicle, the generated sound generated or stored by the mobile device may be transmitted to the wearable device, so that the user operating the vehicle may be alerted.

The group identifying module 234 may further include instructions or program codes related to a function and/or operation of identifying another group that includes at least one ambient sound, based on a change in volume information of the at least one ambient sound.

In an embodiment of the disclosure, the processor 210 may execute the instructions or program codes of the group identifying module 234 to predict a distance between the vehicle and at least one sound source based on the volume information of at least one ambient sound produced from the sound source.

In an embodiment of the disclosure, the processor 210 may execute the instructions or program codes of the group identifying module 234 to determine that the distance between the vehicle and the sound source that outputs the at least one ambient sound increases, when the volume of the at least one ambient sound decreases.

For example, in an embodiment of the disclosure, the processor 210 may execute the instructions or program codes of the group identifying module 234 to determine that the distance between the vehicle and a sound source that outputs a siren sound has decreased and then increased, when the volume of the siren sound has increased and then decreased.

For example, in an embodiment of the disclosure, the processor 210 may execute the instructions or program codes of the group identifying module 234 to determine that the distance between the vehicle and a sound source that outputs a siren sound increases, when recognizing a change in volume of the siren sound from 90 dB to 50 dB. However, it is not limited thereto.

In an embodiment of the disclosure, the processor 210 may execute the instructions or program codes of the group identifying module 234 to determine that the distance between the vehicle and the sound source that outputs the at least one ambient sound decreases, when the volume of the at least one ambient sound increases.

For example, in an embodiment of the disclosure, the processor 210 may execute the instructions or program codes of the group identifying module 234 to determine that the distance between the vehicle and a sound source that outputs a horn sound has increased and then decreased, when the volume of the horn sound has decreased and then increased.

For example, in an embodiment of the disclosure, the processor 210 may execute the instructions or program codes of the group identifying module 234 to determine that the distance between the vehicle and a sound source that outputs a horn sound decreases, when recognizing a change in volume of the horn sound from 40 dB to 100 dB. However, it is not limited thereto.

In an embodiment of the disclosure, the processor 210 may execute the instructions or program codes of the group identifying module 234 to identify a group that includes the at least one ambient sound among a plurality of preset groups, based on the volume information of the at least one ambient sound.

In an embodiment of the disclosure, the processor 210 may execute the instructions or program codes of the group identifying module 234 to identify a group that includes the at least one ambient sound among a plurality of preset groups, based on a change in volume of the at least one ambient sound being recognized.

For example, in an embodiment of the disclosure, the processor 210 may recognize a nearby horn sound based on the volume information and type information of the at least one ambient sound. In an embodiment of the disclosure, the processor 210 may execute the instructions or program codes of the group identifying module 234 to identify that the at least one ambient sound identified as a nearby horn sound is included in group 1.

In an embodiment of the disclosure, the processor 210 may execute the instructions or program codes of the group identifying module 234 to recognize a change in volume information of the horn sound. For example, the processor 210 may recognize that the nearby horn sound has changed to a distant horn sound. In an embodiment of the disclosure, the processor 210 may execute the instructions or program codes of the group identifying module 234 to identify that the at least one ambient sound identified as a distant horn sound is included in group 2. However, it is not limited thereto.

For example, in an embodiment of the disclosure, the processor 210 may recognize a distant brake friction sound based on the volume information and type information of the at least one ambient sound. In an embodiment of the disclosure, the processor 210 may execute the instructions or program codes of the group identifying module 234 to identify that the at least one ambient sound identified as a distant brake friction sound is included in group 2.

In an embodiment of the disclosure, the processor 210 may execute the instructions or program codes of the group identifying module 234 to recognize a change in volume information of the brake friction sound. For example, the processor 210 may recognize that the distant brake friction sound has changed to a nearby brake friction sound. In an embodiment of the disclosure, the processor 210 may execute the instructions or program codes of the group identifying module 234 to identify that the at least one ambient sound identified as a nearby brake friction sound is included in group 1. However, it is not limited thereto.

The sound data transmitting module 236 may further include instructions or program codes related to a function and/or operation of determining whether to transmit at least one ambient sound to the mobile device, based on at least one of driving information of the vehicle and surrounding environment information of the vehicle, and a transmission condition corresponding to a changed group when the volume of the at least one ambient sound is changed and the group including the at least one changed ambient sound is changed.

In an embodiment of the disclosure, the processor 210 may execute the instructions or program codes of the group identifying module 234 to determine whether to continue to transmit, to the mobile device, the at least one ambient sound that has been being transmitted, when recognizing a change in volume information of the at least one ambient sound after the at least one ambient sound is transmitted to the mobile device.

In an embodiment of the disclosure, the processor 210 may execute the instructions or program codes of the sound data transmitting module 236 to identify that the group including at least one ambient sound is changed from group 1 to group 2 as the volume of the at least one ambient sound being transmitted to the mobile device is changed to be smaller.

In an embodiment of the disclosure, the processor 210 may execute the instructions or program codes of the sound data transmitting module 236 to determine whether to transmit the at least one ambient sound to the mobile device, based on at least one of the driving information of the vehicle and the surrounding environment information of the vehicle, and the transmission condition corresponding to group 2. However, it is not limited thereto.

In FIG. 2, only essential components illustrating an operation of the electronic device 200 for vehicle are shown, and components included in the electronic device 200 for vehicle are not limited to those shown in FIG. 2.

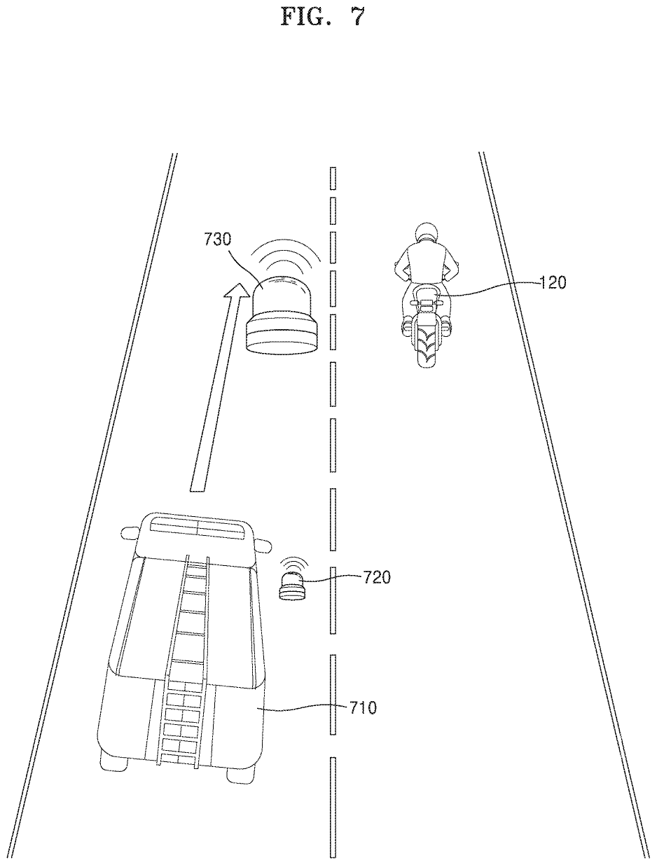

FIG. 7 is a diagram illustrating an embodiment of transmitting an ambient sound from an electronic device for vehicle to a mobile device according to an embodiment of the disclosure.

Referring to FIG. 7, the sound data transmitting module 236 may further include instructions or program codes related to a function and/or operation of transmitting output information of the at least one ambient sound to the mobile device.

In an embodiment of the disclosure, the processor 210 may execute the instructions or program codes of the sound data transmitting module 236 to transmit the output information of the at least one ambient sound to the mobile device.

The output information may include at least one of volume information of the at least one ambient sound or direction information of at least one sound source that outputs the at least one ambient sound.

For example, in an embodiment of the disclosure, the processor 210 may execute the instructions or program codes of the sound data transmitting module 236 to transmit, to the mobile device, the direction information of a sound source outputting at least one ambient sound (e.g., located at 170° to the left), when the at least one ambient sound is output from the sound source located at 170° to the left, when it is assumed that the front of the vehicle is 0°.

For example, in an embodiment of the disclosure, the processor 210 may execute the instructions or program codes of the sound data transmitting module 236 to transmit, to the mobile device, the direction information of a sound source outputting at least one ambient sound (e.g., located at 90° to the right), when the at least one ambient sound is output from the sound source located at 90° to the right, when it is assumed that the front of the vehicle is 0°. However, it is not limited thereto.

For example, in an embodiment of the disclosure, the processor 210 may recognize that a horn sound has occurred at about 100 dB in a short range. The processor 210 may transmit, to the mobile device, volume information (about 100 dB) of a nearby horn sound. However, it is not limited thereto.

For example, in an embodiment of the disclosure, the processor 210 may recognize that the volume of a sound produced from a sound source located in a short range from the vehicle decreases as the distance between the vehicle and the sound source increases (e.g., a case where the volume of the sound decreases from 90 dB to 40 dB). The processor 210 may transmit sound volume change information (indicating that the volume of the sound gradually decreases) to the mobile device.

The mobile device may then transmit, to the wearable device, the sound produced from the sound source such that the sound is output with a gradually decreasing volume. However, it is not limited thereto.

For example, in an embodiment of the disclosure, the processor 210 may recognize that the volume of a sound produced from a sound source 710 located in a long range from the vehicle 120 increases as the distance between the vehicle 120 and the sound source 710 decreases (e.g., a case where the volume of the sound increases from 30 dB to 60 dB). The processor 210 may transmit sound volume change information 720 and 730 (indicating that the volume of the sound gradually increases) to the mobile device.

The mobile device may then transmit, to the wearable device, the sound produced from the sound source such that the sound is output with a gradually increasing volume. However, it is not limited thereto.

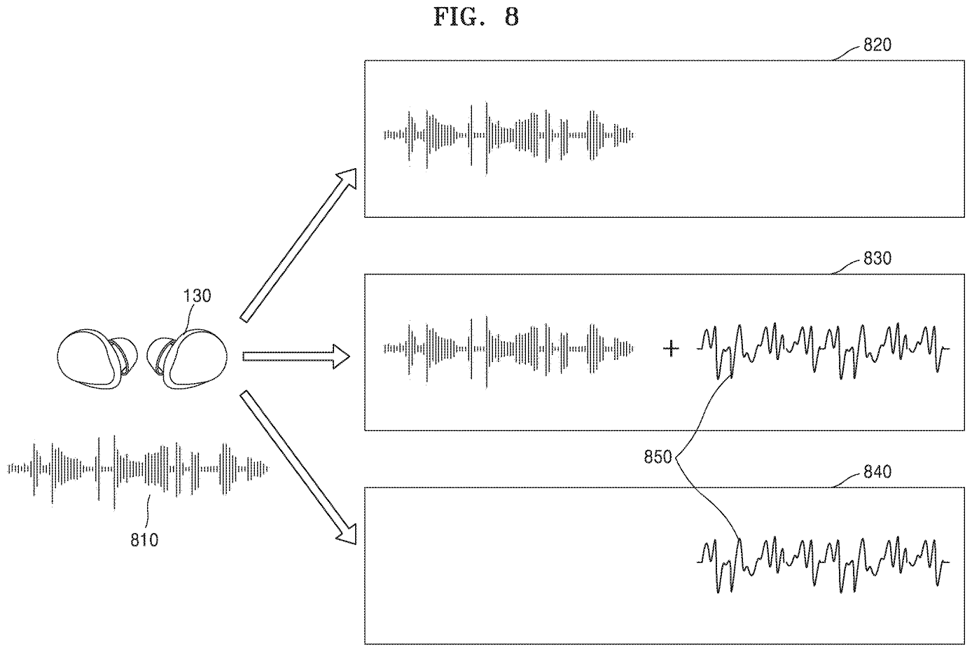

FIG. 8 is a diagram illustrating an operation corresponding to transmission of mixing information to a mobile device from an electronic device for vehicle, according to an embodiment of the disclosure.

Referring to FIG. 8, the sound data transmitting module 236 may further include instructions or program codes related to a function and/or operation of transmitting mixing information of at least one ambient sound to the mobile device.

The mixing information may include information indicating whether to synthesize the at least one ambient sound transmitted to the mobile device with at least one audio data being played on the mobile device.

The audio data may refer to sound output from media being played on the mobile device.

The audio data may include, for example, at least one of music sound or radio sound being played on the mobile device, but is not limited thereto.

In an embodiment of the disclosure, the processor 210 may execute the instructions or program codes of the sound data transmitting module 236 to transmit, to the mobile device, information indicating that at least one ambient sound and at least one audio data being played on the mobile device are not to be synthesized, when the at least one ambient sound included in group 1 with very high importance is recognized.

In this case, the mobile device may block audio data 810 being played to the wearable device 130, and transmit only the at least one ambient sound 850 (in 840).

In an embodiment of the disclosure, the processor 210 may execute the instructions or program codes of the sound data transmitting module 236 to transmit, to the mobile device, information indicating that at least one ambient sound and at least one audio data being played on the mobile device are not to be synthesized, when the at least one ambient sound included in group 3 with low importance is recognized.

In this case, the mobile device may transmit the audio data 810 being played to the wearable device 130, and may not transmit the at least one ambient sound 850 (in 820).

In an embodiment of the disclosure, the processor 210 may execute the instructions or program codes of the sound data transmitting module 236 to transmit, to the mobile device, information indicating that at least one ambient sound and at least one audio data being played on the mobile device are to be synthesized, when the at least one ambient sound included in group 2 with high importance is recognized.

In this case, the mobile device may transmit a sound resulting from synthesizing the at least one ambient sound 850 with the audio data 810 to the wearable device 130 (in 830).

In an embodiment of the disclosure, the processor 210 may execute the instructions or program codes of the sound data transmitting module 236 to transmit the at least one ambient sound, output information and mixing information of the at least one ambient sound to the mobile device.

In this case, the mobile device may transmit, to the wearable device, the sound resulting from synthesizing the audio data with the ambient sound or the at least one ambient sound, based on the output information and mixing information of the at least one ambient sound.

For example, based on the output information and mixing information of the at least one ambient sound, the mobile device may receive information indicating that the at least one ambient sound is recognized with a volume of less than 40 dB from the left of the vehicle, and that the at least one ambient sound is to be synthesized with the audio data. The mobile device may synthesize the at least one ambient sound with the audio data being played, at a lower volume than of the audio data. The mobile device may transmit the synthesized sound to the wearable device worn on the left ear such that the synthesized sound is output from the wearable device.

For example, based on the output information and mixing information of the at least one ambient sound, the mobile device may receive information indicating that the at least one ambient sound is recognized with a volume of 40 dB or more and less than 90 dB from the right of the vehicle, and that the at least one ambient sound is to be synthesized with the audio data. The mobile device may synthesize the at least one ambient sound with the audio data being played, at a higher volume than of the audio data. The mobile device may transmit the synthesized sound to the wearable device worn on the right ear such that the synthesized sound is output from the wearable device.

For example, based on the output information and mixing information of the at least one ambient sound, the mobile device may receive mixing information indicating that the at least one ambient sound is recognized with a volume of 90 dB or more from the right of the vehicle, and that the at least one ambient sound is not to be synthesized with the audio data being played. The mobile device may transmit at least one ambient sound to the wearable device worn on the right ear such that only the at least one ambient sound is output from the wearable device at a large volume. However, it is not limited thereto.

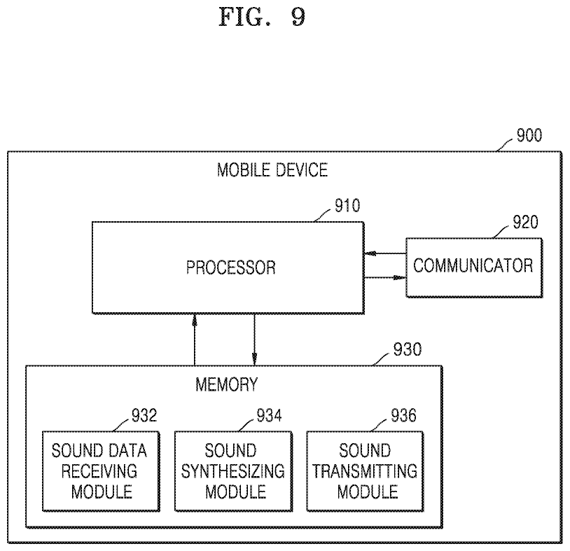

FIG. 9 is a block diagram illustrating components of a mobile device according to an embodiment of the disclosure.

Referring to FIG. 9, a mobile device 900 may include a communicator 920 that performs communication with the electronic device for vehicle and the wearable device, memory 930 that stores at least one instruction, and at least one processor 910 that executes the at least one instruction stored in the memory 930.

The memory 930 may store various data, programs, or applications for driving and controlling the mobile device 900 according to an embodiment of the disclosure. The memory 930 may include, for example, non-volatile memory including at least one of flash memory, hard disk, multimedia card micro type memory, card type memory (e.g., SD or XD memory), read-only memory (ROM), electrically erasable programmable ROM (EEPROM), or programmable ROM (PROM), and volatile memory, such as random access memory (RAM) or static RAM (SRAM).

Instructions, data structures, and program codes that are readable by the processor 910 may be stored in the memory 930. In the following embodiments of the disclosure, the processor 910 may be implemented by executing instructions or codes of the program stored in the memory 930.

The programs stored in the memory 930 may be classified into a plurality of modules according to the functions, which include, for example, a sound data receiving module 932, a sound synthesizing module 934, and a sound transmitting module 936.

However, the instructions or codes of the program stored in the memory 930 are not limited thereto. For example, the sound data receiving module 932, the sound synthesizing module 923 and the sound transmitting module 936 are components for an embodiment of the disclosure, and the configurations of the modules included in the memory 930 may be integrated, added or omitted depending on the specification of the mobile device 900 that is actually implemented. In other words, two or more modules may be merged into one, or a single module may be split into two or more modules as needed.

The sound data receiving module 932, sound synthesizing module 934 and sound transmitting module 936 stored in the memory 930 may refer to units of processing the functions or operations performed by the processor 910, and may be implemented in software, such as instructions, algorithms, data structures or program codes.

The processor 910 may include hardware components for performing arithmetic, logical, and input/output operations and signal processing. The processor 910 may include at least one of e.g., central processing units (CPUs), microprocessors, graphics processing units (GPUs), application specific integrated circuits (ASIC), digital signal processors (DSPs), digital signal processing devices (DSPDs, programmable logic devices (PLDs), and field programmable gate arrays (FPGAs), without being limited thereto.

The communicator 920 may perform communication with an external device or server over at least one cable or wireless communication network according to the processor 910. In an embodiment of the disclosure, the communicator 920 may include at least one short-range communication module for performing communication according to a communication standard, such as Bluetooth, Wi-Fi, Bluetooth low energy (BLE), NFC/RFID, Wi-Fi direct, UWB or ZIGBEE, and a long-range communication module for performing communication with a server for supporting the long-range communication according to a long-range communication standard. The long-range communication module may perform communication over a communication network that conforms to 3G, 4G and/or 5G communication standards, or over a network for Internet communication.

In an embodiment of the disclosure, the mobile device 900 may be connected to the electronic device for vehicle through the communicator 920.

In an embodiment of the disclosure, the mobile device 900 may be wirelessly connected to the wearable device through the communicator 920.

The sound data receiving module 932 may be configured with instructions or program codes related to a function and/or operation of receiving at least one sound or occurrence information of the at least one ambient sound from the electronic device for vehicle.

In an embodiment of the disclosure, the processor 910 may execute the instructions or program codes of the sound data receiving module 932 to receive at least one sound or occurrence information of the at least one ambient sound from the electronic device for vehicle.

The occurrence information of the at least one ambient sound may include information indicating that at least one ambient sound has occurred.

For example, the occurrence information of the at least one ambient sound may include information indicating that a nearby horn sound has occurred, when the electronic device for vehicle recognizes the nearby horn sound.

For example, the occurrence information of the at least one ambient sound may include information indicating that a distant siren sound has occurred, when the electronic device for vehicle recognizes the distant siren sound. However, it is not limited thereto.

The sound synthesizing module 934 may be configured with instructions or program codes related to a function and/or operation of synthesizing at least one ambient sound or a generated sound corresponding to the occurrence information of the at least one ambient sound with audio data being played.

In an embodiment of the disclosure, the processor 910 may execute the instructions or program codes of the sound synthesizing module 934 to synthesize the at least one ambient sound or the generated sound corresponding to the occurrence information of the at least one ambient sound with audio data being played.

The audio data may refer to sound output from media being played on the mobile device.

The audio data may include, for example, at least one of music sound or radio sound being played on the mobile device, but is not limited thereto.

In an embodiment of the disclosure, the processor 910 may execute the instructions or program codes of the sound synthesizing module 934 to create a generated sound corresponding to the occurrence information of the at least one ambient sound based on an artificial intelligence model.

In an embodiment of the disclosure, the processor 910 may execute the instructions or program codes of the sound synthesizing module 934 to store the generated sound corresponding to the occurrence information of the at least one ambient sound in the memory 930 of the mobile device 900 according to an embodiment of the disclosure.

The generated sound corresponding to the occurrence information of the at least one ambient sound may refer to a nearby horn sound stored in the memory 930 or created based on the artificial intelligence model by the processor 910 according to an embodiment of the disclosure executing the instructions or program codes of the sound synthesizing module 934, when the occurrence information of the at least one ambient sound includes information indicating that the nearby horn sound has occurred. However, it is not limited thereto.

The generated sound corresponding to the occurrence information of the at least one ambient sound may refer to a distant siren sound stored in the memory or created based on the artificial intelligence model by the processor 910 according to an embodiment of the disclosure executing the instructions or program codes of the sound synthesizing module 934, when the occurrence information of the at least one ambient sound includes information indicating that the distant siren sound has occurred. However, it is not limited thereto.

The sound transmitting module 936 may be configured with instructions or program codes related to a function and/or operation of transmitting the synthesized sound to the mobile device.

In an embodiment of the disclosure, the processor 910 may execute the instructions or program codes of the sound transmitting module 936 to transmit the synthesized sound to the wearable device.

Hence, even when latency occurs when the mobile device 900 according to an embodiment of the disclosure receives at least one ambient sound from the electronic device for vehicle, the processor 910 according to an embodiment of the disclosure may execute the instructions or program codes of the sound transmitting module 936 to transmit the generated sound corresponding to the occurrence information of the at least one ambient sound to the wearable device, thereby alerting the user who is operating the vehicle.

The sound data receiving module 932 may further include instructions or program codes related to a function and/or operation of receiving output information of the at least one ambient sound from the electronic device for vehicle.

In an embodiment of the disclosure, the processor 910 may execute the instructions or program codes of the sound data receiving module 932 to receive output information of the at least one ambient sound from the electronic device for vehicle.

The output information may include at least one of volume information of the at least one ambient sound or direction information of at least one sound source that outputs the at least one ambient sound.

For example, in an embodiment of the disclosure, the processor 910 may execute the instructions or program codes of the sound data receiving module 932 to receive, from the electronic device for vehicle, the direction information of a sound source outputting at least one ambient sound (e.g., located at 170° to the left), when the at least one ambient sound is output from the sound source located at 170° to the left, when it is assumed that the front of the vehicle is 0°.

For example, in an embodiment of the disclosure, the processor 910 may execute the instructions or program codes of the sound data receiving module 932 to receive, from the electronic device for vehicle, the direction information of a sound source outputting at least one ambient sound (e.g., located at 90° to the right), when the at least one ambient sound is output from the sound source located at 90° to the right, when it is assumed that the front of the vehicle is 0°. However, it is not limited thereto.

For example, in an embodiment of the disclosure, the processor 910 may execute instructions or program codes of the sound data receiving module 932 to receive volume information (about 100 dB) of a nearby horn sound from the electronic device for vehicle, when the electronic device for vehicle recognizes that the horn sound has occurred in a short range at about 100 dB. However, it is not limited thereto.

The sound transmitting module 936 may further include instructions or program codes related to a function and/or operation of adjusting at least one of the volume or direction of the synthesized sound in the output information.

In an embodiment of the disclosure, the processor 910 may execute the instructions or program codes of the sound transmitting module 936 to adjust at least one of the volume or direction of the synthesized sound.

For example, in an embodiment of the disclosure, the processor 910 may receive, from the electronic device for vehicle, output information indicating that at least one sound source outputting at least one ambient sound is located on the right of the vehicle. In an embodiment of the disclosure, the processor 910 may execute the instructions or program codes of the sound transmitting module 936 to adjust the direction of at least one synthesized sound such that at least one ambient sound is output from the wearable device worn on the right ear. However, it is not limited thereto.

For example, in an embodiment of the disclosure, the processor 910 may receive, from the electronic device for vehicle, output information indicating that at least one sound source outputting at least one ambient sound is located on the left of the vehicle and the volume of the at least one ambient sound is 100 dB. In an embodiment of the disclosure, the processor 910 may execute the instructions or program codes of the sound transmitting module 936 to adjust the volume and direction of a synthesized sound such that at least one ambient sound is output from the wearable device worn on the left ear at a larger volume than of audio data being output.

For example, in an embodiment of the disclosure, the processor 910 may receive, from the electronic device for vehicle, output information indicating that at least one sound source outputting at least one ambient sound is located on the right of the vehicle and that the volume of the at least one ambient sound is 40 dB. In an embodiment of the disclosure, the processor 910 may execute the instructions or program codes of the sound transmitting module 936 to adjust the volume and direction of the synthesized sound such that at least one ambient sound is output from the wearable device worn on the right ear at a lower volume than of the audio data being output. However, it is not limited thereto.

For example, in an embodiment of the disclosure, the processor 910 may receive, from the electronic device for a vehicle, sound volume change information indicating that the volume of a sound produced from a sound source located in a short range from the vehicle decreases (e.g., the volume of the sound decreases from 90 dB to 40 dB) as the distance between the vehicle and the sound source increases. In an embodiment of the disclosure, the processor 910 may execute the instructions or program codes of the sound transmitting module 936 to adjust the volume of at least one synthesized sound such that the sound is output with the gradually decreasing volume to the wearable device. However, it is not limited thereto.

For example, in an embodiment of the disclosure, the processor 910 may receive, from the electronic device for vehicle, sound volume change information indicating that the volume of the sound produced from a sound source located in a long range from the vehicle increases (e.g., the volume of the sound decreases from 30 dB to 60 dB) as the distance between the vehicle and the sound source decreases. In an embodiment of the disclosure, the processor 910 may execute the instructions or program codes of the sound transmitting module 936 to adjust the volume of the synthesized sound such that the sound is output with the gradually increasing volume to the wearable device. However, it is not limited thereto.

The sound transmitting module 936 may further include instructions or program codes related to a function and/or operation of transmitting the adjusted sound to the wearable device.

In an embodiment of the disclosure, the processor 910 may execute the instructions or program codes of the sound transmitting module 936 to transmit the adjusted sound to the wearable device.

In FIG. 9, only essential components illustrating an operation of the mobile device 900 are shown, and components included in the mobile device 900 are not limited to those shown in FIG. 9.

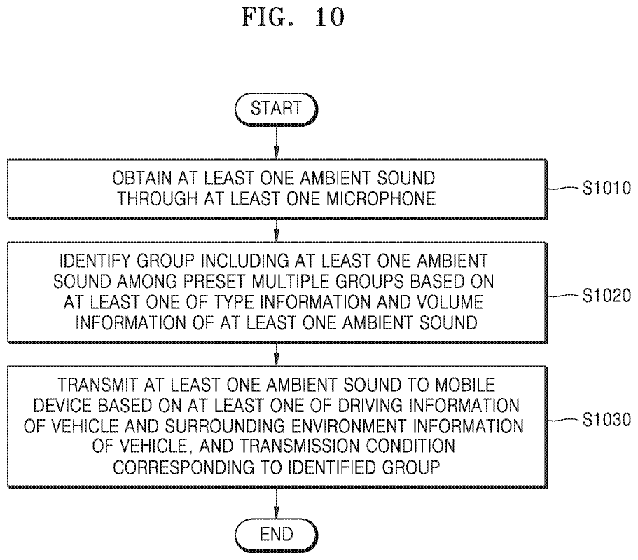

FIG. 10 is a flowchart illustrating an operating method of an electronic device for vehicle according to an embodiment of the disclosure.

Referring to FIG. 10, in operation S1010, the electronic device for vehicle may obtain at least one ambient sound through at least one microphone.

In an embodiment of the disclosure, when noise is obtained along with the ambient sound, the electronic device for vehicle may reduce or eliminate the noise.

In an embodiment of the disclosure, the electronic device for vehicle may reduce or eliminate, through a filter, the noise obtained along with the ambient sound.

The filter may include at least one of, for example, a band-pass filter, a moving average filter, an FIR filter or an IIR filter, but is not limited thereto.

In an embodiment of the disclosure, the electronic device for vehicle may cancel the noise obtained along with the at least one ambient sound, based on white noise corresponding to the noise.

In an embodiment of the disclosure, the electronic device for vehicle may reduce the noise obtained along with the at least one ambient sound, based on destructive interference.

In operation S1020, the electronic device for vehicle may identify a group that includes the at least one ambient sound among a plurality of preset groups, based on at least one of type information and volume information of the at least one ambient sound.

In an embodiment of the disclosure, the electronic device for vehicle may identify type information of the at least one ambient sound, based on an artificial intelligence model.

The artificial intelligence technology (hereinafter, AI technology) is a technology to obtain a desired result by performing processes, such as analysis and/or classification on input data based on operations through a neural network.

The AI technology may be implemented by using an algorithm. The algorithm or a set of algorithms to implement the AI technology is called the neural network. The neural network may receive input data, and perform an operation for the analysis and/or classification to output resulting data. As such, in order for the neural network to output accurate resulting data corresponding to the input data, the neural network needs to be trained. The training may refer to training the neural network to discover or learn, by the neural network itself, a method of inputting various data to the neural network and analyzing the input data, a method of classifying the input data and/or a method of extracting features required to generate resulting data from the input data. Specifically, through the training procedure, the neural network may be trained with training data (e.g., a plurality of different images) to optimize and set weight values in the neural network. A desired result is then output by learning the input data through the neural network having the optimized weight values.

Specifically, when there are a plurality of hidden layers in the neural network, which perform operations, i.e., when the depth of the neural network for performing operations increases, the neural network may be classified as a deep neural network (DNN). The neural network may include, for example, a convolutional neural network (CNN), a DNN, a recurrent neural network (RNN), a restricted Boltzmann machine (RBM), a deep belief network (DBN), a bidirectional recurrent deep neural network (BRDNN), and a deep Q-network, without being limited thereto. The neural network may also be subdivided. For example, the CNN neural network may be subdivided into a deep convolution neural network (DCNN) or a Capsnet neural network.

In a disclosed embodiment of the disclosure, an AI model may refer to a neural network including at least one layer that operates to receive input data and output a desired result. Furthermore, the AI model may refer to an algorithm that performs an operation through the neural network to output a desired result, a set of a plurality of algorithms, a processor for executing the algorithm or the set of algorithms, software for executing the algorithm or the set of algorithms or hardware for executing the algorithm or the set of algorithms.

The structure of the neural network was described above (see FIG. 4), so the redundant description will be omitted.

In an embodiment of the disclosure, the electronic device for vehicle may use a lossless waveform audio format (wav) for training data to train an AI model.

In an embodiment of the disclosure, the electronic device for vehicle may normalize peaks of sound frequency data and extract features of the frequency data.

In an embodiment of the disclosure, the electronic device for vehicle may train the AI model based on the features of the frequency data, and training data

In an embodiment of the disclosure, the electronic device for vehicle may identify type information of at least one ambient sound by comparing the at least one ambient sound obtained through at least one microphone with the training data.

For example, in an embodiment of the disclosure, the electronic device for vehicle may obtain a sound produced from a sound source located around the vehicle through at least one microphone. The electronic device for vehicle may identify that the obtained sound corresponds to a horn sound by comparing features of the frequency data of the obtained sound with the training data.

For example, in an embodiment of the disclosure, the electronic device for vehicle may obtain a sound produced from a sound source located around the vehicle through the at least one microphone. The electronic device for vehicle may identify that the obtained sound corresponds to a siren sound by comparing features of the frequency data of the obtained sound with the training data. However, it is not limited thereto.

The AI model may be trained by a server capable of communicating with the electronic device for vehicle according to an embodiment of the disclosure over a wireless communication network. For example, the external server may train the AI model, and transmit the trained AI model to the electronic device for vehicle.

A method by which the server capable of communicating with the electronic device for vehicle according to an embodiment of the disclosure over a wireless communication network trains the AI model was described above (see FIGS. 5 and 6), so the redundant description will be omitted.

In an embodiment of the disclosure, the electronic device for vehicle may recognize at least one ambient sound, and obtain volume information indicating the volume of the ambient sound.

In an embodiment of the disclosure, the electronic device for vehicle may obtain the volume information of the at least one ambient sound in a decibel (dB) value.

In an embodiment of the disclosure, the electronic device for vehicle may identify a group that includes the at least one ambient sound among a plurality of preset groups, based on at least one of type information of the at least one ambient sound and volume information of the at least one ambient sound.

The plurality of preset groups may be classified into group 1, group 2 or group 3 according to the importance of the ambient sounds. However, the number of groups included in the plurality of preset groups is not limited thereto.

The importance may refer to the degree to which the driving of the vehicle is affected.

For example, that the importance of an ambient sound is very high may mean that, when the ambient sound is not perceived, there is a very high possibility of an accident occurring with the vehicle that includes the electronic device for vehicle according to an embodiment of the disclosure.

For example, that the importance of an ambient sound is high may mean that, when the ambient sound is not perceived, there is a high possibility of an accident occurring with the vehicle that includes the electronic device for vehicle according to an embodiment of the disclosure.

For example, that the importance of an ambient sound is low may mean that, when the ambient sound is not perceived, there is a low possibility of an accident occurring with the vehicle that includes the electronic device for vehicle according to an embodiment of the disclosure.

In an embodiment of the disclosure, the electronic device for vehicle may add at least one sound with very high importance to group 1.

At least one sound included in group 1 may include at least one of, for example, a short-range horn sound, a short-range siren sound, an explosion sound, an impact sound, or a short-range brake friction sound, but is not limited thereto.

In an embodiment of the disclosure, the electronic device for vehicle may add at least one sound with high importance to group 2.

At least one sound included in group 2 may include at least one of, for example, a long-range horn sound, a long-range siren sound, or a long-range brake friction sound, but is not limited thereto.

In an embodiment of the disclosure, the electronic device for vehicle may add at least one sound with low importance to group 3.

At least one sound included in group 3 may include at least one of, for example, a road friction sound or a driving sound of an adjacent vehicle, but is not limited thereto.

In an embodiment of the disclosure, the electronic device for vehicle may store the at least one sound included in group 1, group 2 or group 3 in memory for each group.

The at least one sound included in group 1, group 2 or group 3 may be separately changed by the user.

In an embodiment of the disclosure, the electronic device for vehicle may predict a distance between the vehicle and the sound source based on the volume information of the sound produced from the at least one sound source.

For example, in an embodiment of the disclosure, the electronic device for vehicle may identify a sound produced from at least one sound source as a horn sound. When the volume of the horn sound is identified as being 90 dB or higher, the electronic device for vehicle may predict that the distance (short distance) between the at least one sound source that outputs the horn sound and the vehicle is within a preset distance.

For example, in an embodiment of the disclosure, the electronic device for vehicle may identify a sound produced from at least one sound source as a siren sound. When the volume of the siren sound is identified as being 90 dB or lower, the electronic device for vehicle may predict that the distance (long distance) between the at least one sound source that outputs the siren sound and the vehicle is equal to or longer than the preset distance.

For example, in an embodiment of the disclosure, the electronic device for vehicle may identify a sound produced from at least one sound source as an explosion sound. When the volume of the explosion sound is identified as being 100 dB or higher, the electronic device for vehicle may predict that the distance (short distance) between the at least one sound source that outputs the explosion sound and the vehicle is within the preset distance.

For example, in an embodiment of the disclosure, the electronic device for vehicle may identify a sound produced from at least one sound source as a brake friction sound. When the volume of the brake friction sound is identified as being 100 dB or higher, the electronic device for vehicle may predict that the distance (short distance) between the at least one sound source that outputs the brake friction sound and the vehicle is within the preset distance. However, it is not limited thereto.

In an embodiment of the disclosure, the electronic device for vehicle may identify a group that includes the at least one ambient sound among a plurality of preset groups, based on at least one of type information of the at least one ambient sound and volume information of the at least one ambient sound.

For example, when the electronic device for vehicle according to an embodiment of the disclosure identifies a sound produced from at least one sound source as a horn sound, and the volume of the horn sound is 90 dB or higher, the electronic device for vehicle according to an embodiment of the disclosure may identify that the sound produced from the at least one sound source corresponds to a nearby horn sound.

In this case, the electronic device for vehicle according to an embodiment of the disclosure may identify that the identified nearby horn sound is included in group 1 with very high importance among the plurality of preset groups.

For example, when the electronic device for vehicle according to an embodiment of the disclosure identifies a sound produced from at least one sound source as a brake friction sound, and the volume of the brake friction sound is 90 dB or higher, the electronic device for vehicle according to an embodiment of the disclosure may identify that the sound produced from the at least one sound source corresponds to a nearby brake friction sound. The electronic device for vehicle according to an embodiment of the disclosure may identify that the identified nearby brake friction sound is included in group 1 with very high importance among the plurality of preset groups.

For example, when the electronic device for vehicle according to an embodiment of the disclosure identifies a sound produced from at least one sound source as a siren sound, and the volume of the horn sound is less than 90 dB, the electronic device for vehicle according to an embodiment of the disclosure may identify that the sound produced from the at least one sound source corresponds to a distant siren sound. The electronic device for vehicle according to an embodiment of the disclosure may identify that the identified distant siren sound is included in group 2 with high importance among the plurality of preset groups.

For example, when the electronic device for vehicle according to an embodiment of the disclosure identifies a sound produced from at least one sound source as a road friction sound, and the volume of the road friction sound is less than 50 dB, the electronic device for vehicle according to an embodiment of the disclosure may identify that the identified road friction sound is included in group 3 with low importance among the plurality of preset groups.

In operation S1030, the electronic device for vehicle may transmit the at least one ambient sound to the mobile device, based on at least one of driving information of the vehicle and surrounding environment information of the vehicle, and a transmission condition corresponding to the identified group.

The driving information of the vehicle may include at least one of speed information of the vehicle or speed change information of the vehicle.

The surrounding environment information of the vehicle may include at least one of location information of at least one sound source that outputs at least one ambient sound, weather information around the vehicle or speed information of an external vehicle located around the vehicle.

The electronic device for vehicle according to an embodiment of the disclosure may obtain the surrounding environment information of the vehicle through vehicle to everything (V2X) communication.

The V2X communication refers to communication through which the vehicle may exchange information with infrastructure-equipped objects, such as other vehicles and roads, based on at least one of cable or wireless network.

The V2X communication may include at least one of vehicle to vehicle (V2V) communication, vehicle to infrastructure (V2I) communication, vehicle to network (V2N) communication, or vehicle to pedestrian (V2P) communication.

The electronic device for vehicle according to an embodiment of the disclosure may obtain surrounding environment information of the vehicle through at least one sensor.

The sensor may include at least one of a global positioning system (GPS) sensor, a sound detection sensor, an image sensor, a camera, Lidar or radar, but is not limited thereto.

The electronic device for vehicle according to an embodiment of the disclosure may set a transmission condition for each of the plurality of preset groups.

The electronic device for vehicle according to an embodiment of the disclosure may set a sound included in group 1 to be transmitted to the mobile device, regardless of the driving information of the vehicle and the surrounding environment information of the vehicle.

The electronic device for vehicle according to an embodiment of the disclosure may identify at least one ambient sound with very high importance as being included in group 1. The electronic device for vehicle according to an embodiment of the disclosure may transmit the at least one ambient sound to the mobile device regardless of the driving information of the vehicle and the surrounding environment information of the vehicle.

For example, the electronic device for vehicle according to an embodiment of the disclosure may identify a sound produced from at least one sound source as a horn sound. The electronic device for vehicle may identify that the identified horn sound corresponds to a nearby horn sound, based on the volume information of the horn sound. The electronic device for vehicle may identify that the nearby horn sound is included in group 1 of the plurality of preset groups. The electronic device for vehicle may transmit the nearby horn sound to the mobile device regardless of the driving information of the vehicle (e.g., driving speed of the vehicle).

For example, the electronic device for vehicle according to an embodiment of the disclosure may identify a sound produced from at least one sound source as an explosion sound. The electronic device for vehicle may identify, based on the volume information of the explosion sound, that the identified explosion sound corresponds to a nearby explosion sound and is included in group 1 of the plurality of preset groups. The electronic device for vehicle may transmit the nearby explosion sound to the mobile device regardless of the driving information of the vehicle (e.g., driving speed of the vehicle). It is not, however, limited thereto.

The electronic device for vehicle according to an embodiment of the disclosure may set a transmission condition for transmitting a sound included in group 2 to the mobile device, based on at least one of the driving information of the vehicle and the surrounding environment information of the vehicle.

The electronic device for vehicle according to an embodiment of the disclosure may identify at least one ambient sound with high importance as being included in group 2. The electronic device for vehicle according to an embodiment of the disclosure may transmit the at least one sound included in group 2 to the mobile device, based on at least one of the driving information of the vehicle and the surrounding environment information of the vehicle.

For example, the electronic device for vehicle according to an embodiment of the disclosure may identify a sound produced from at least one sound source as a horn sound. The electronic device for vehicle according to an embodiment of the disclosure may identify, based on the volume information of the horn sound, that the identified horn sound corresponds to a distant horn sound and corresponds to group 2 of the plurality of preset groups. The electronic device for vehicle may transmit the distant horn sound to the mobile device, based on at least one of speed of the vehicle, location information of a vehicle that generates the horn sound, and speed information of the vehicle that generates the horn sound.

For example, the electronic device for vehicle according to an embodiment of the disclosure may identify a sound produced from at least one sound source as a brake friction sound. The electronic device for vehicle may identify, based on the volume information of the brake friction sound, that the identified brake friction sound corresponds to a distant brake friction sound and corresponds to group 2 of the plurality of preset groups. The electronic device for vehicle may transmit the distant brake friction sound to the mobile device, based on at least one of speed of the vehicle, weather information around the vehicle or speed information of the vehicle that produces the brake friction sound. However, it is not limited thereto.

The electronic device for vehicle according to an embodiment of the disclosure may identify at least one ambient sound with high importance as being included in group 2. The electronic device for vehicle may transmit the at least one sound included in group 2 to the mobile device, based on the driving information of the vehicle.

The driving information of the vehicle may include at least one of speed information of the vehicle or speed change information of the vehicle.

The electronic device for vehicle according to an embodiment of the disclosure may transmit at least one sound included in group 2 to the mobile device, based on the speed information of the vehicle that includes the electronic device for vehicle.

For example, the electronic device for vehicle may identify a sound produced from at least one sound source as a brake friction sound. The electronic device for vehicle according to an embodiment of the disclosure may identify, based on the volume information of the brake friction sound, that the identified brake friction sound corresponds to a distant brake friction sound and corresponds to group 2 of the plurality of preset groups. The electronic device for vehicle according to an embodiment of the disclosure may transmit the distant brake friction sound to the mobile device, when the vehicle that includes the electronic device for vehicle is driving at high speed.

High-speed driving may refer to a case that the vehicle including the electronic device for vehicle according to an embodiment of the disclosure is driving at or above a certain speed.

The certain speed may be set based on speed limits of the road on which the vehicle including the electronic device for vehicle according to an embodiment of the disclosure is driving. However, it is not limited thereto.

The electronic device for vehicle according to an embodiment of the disclosure may obtain information about the speed limits of the road on which the vehicle including the electronic device for vehicle is driving, through V2X communication.

For example, the electronic device for vehicle according to an embodiment of the disclosure may set the certain speed to 30 km/h, when the vehicle including the electronic device for vehicle is driving on a road with a speed limit of 30 km/h.

For example, the electronic device for vehicle according to an embodiment of the disclosure may set the certain speed to 100 km/h, when the vehicle including the electronic device for vehicle is driving on a road with a speed limit of 100 km/h. However, it is not limited thereto.

The certain speed may be changed by the user.

For example, the user may set the certain speed to 80 km/h regardless of the speed limits of the road on which the vehicle including the electronic device for vehicle according to an embodiment of the disclosure is driving.

For example, the user may set the certain speed to 100 km/h regardless of the speed limits of the road on which the vehicle including the electronic device for vehicle according to an embodiment of the disclosure is driving. However, it is not limited thereto.

The electronic device for vehicle according to an embodiment of the disclosure may transmit at least one sound included in group 2 to the mobile device, based on speed change information of the vehicle that includes the electronic device for vehicle.

The speed change information of the vehicle may include at least one of sudden acceleration or sudden deceleration.

Sudden acceleration may refer to a sudden increase in speed of the vehicle including the electronic device for vehicle according to an embodiment of the disclosure in a short period of time.

For example, sudden acceleration may refer to an increase in speed of the vehicle including the electronic device for vehicle according to an embodiment of the disclosure by a speed of 2.8 m/s or more, but is not limited thereto.

Sudden deceleration may refer to a sudden decrease in speed of the vehicle including the electronic device for vehicle according to an embodiment of the disclosure in a short period of time.

For example, sudden deceleration may refer to a decrease in speed of the vehicle including the electronic device for vehicle according to an embodiment of the disclosure by a speed of 2.8 m/s or more, but is not limited thereto.

For example, the electronic device for vehicle may identify a sound produced from at least one sound source as a brake friction sound. The electronic device for vehicle according to an embodiment of the disclosure may identify, based on the volume information of the brake friction sound, that the identified brake friction sound corresponds to a distant brake friction sound and corresponds to group 2 of the plurality of preset groups. The electronic device for vehicle according to an embodiment of the disclosure may not transmit the distant brake friction sound to the mobile device, when the vehicle that includes the electronic device for vehicle is driving at low speed.

The electronic device for vehicle according to an embodiment of the disclosure may transmit the distant brake friction sound to the mobile device, when the vehicle that includes the electronic device for vehicle accelerates rapidly. The distant brake friction sound may refer to a brake friction sound produced from a sound source located in a direction in which the vehicle including the electronic device for vehicle according to an embodiment of the disclosure accelerates rapidly. However, it is not limited thereto.

For example, the electronic device for vehicle may identify a sound produced from at least one sound source as a horn sound. The electronic device for vehicle according to an embodiment of the disclosure may identify, based on the volume information of the horn sound, that the identified horn sound corresponds to a distant horn sound and corresponds to group 2 of the plurality of preset groups. The electronic device for vehicle according to an embodiment of the disclosure may not transmit the distant horn sound to the mobile device, when the vehicle including the electronic device for vehicle is driving at low speed. However, it is not limited thereto.

The electronic device for vehicle according to an embodiment of the disclosure may transmit the distant horn sound to the mobile device, when the vehicle including the electronic device for vehicle decelerates rapidly. The distant horn sound may refer to a brake friction sound produced from a sound source located behind the vehicle including the electronic device for vehicle according to an embodiment of the disclosure. However, it is not limited thereto.

Low-speed driving may refer to a case that the vehicle including the electronic device for vehicle according to an embodiment of the disclosure is driving at less than a certain speed.

The certain speed may be set based on speed limits of the road on which the vehicle including the electronic device for vehicle according to an embodiment of the disclosure is driving. However, it is not limited thereto.

The electronic device for vehicle according to an embodiment of the disclosure may obtain information about the speed limits of the road on which the vehicle including the electronic device for vehicle is driving, through V2X communication. However, it is not limited thereto.

For example, the electronic device for vehicle according to an embodiment of the disclosure may set the certain speed of the vehicle to 30 km/h, when the vehicle including the electronic device for vehicle is driving on a road with a speed limit of 30 km/h.

For example, the electronic device for vehicle according to an embodiment of the disclosure may set the certain speed of the vehicle to 80 km/h, when the vehicle including the electronic device for vehicle is driving on a road with a speed limit of 80 km/h. However, it is not limited thereto.

The certain speed may be changed by the user.

For example, the user may set the certain speed of the vehicle to 50 km/h regardless of the speed limits of the road on which the vehicle including the electronic device for vehicle according to an embodiment of the disclosure is driving.

For example, the user may set the certain speed of the vehicle to 100 km/h regardless of the speed limits of the road on which the vehicle including the electronic device for vehicle according to an embodiment of the disclosure is driving.

The electronic device for vehicle according to an embodiment of the disclosure may identify at least one ambient sound with high importance as being included in group 2. The electronic device for vehicle may transmit the at least one sound included in group 2 to the mobile device, based on the surrounding environment information.

The surrounding environment information of the vehicle may include at least one of location information of at least one sound source that outputs at least one ambient sound, weather information around the vehicle or speed information of an external vehicle located around the vehicle. However, it is not limited thereto.

The electronic device for vehicle may identify a sound produced from at least one sound source as a rain sound. The electronic device for vehicle according to an embodiment of the disclosure may obtain precipitation information based on the volume information of the rain sound.

The electronic device for vehicle according to an embodiment of the disclosure may transmit at least one sound included in group 2 to the mobile device, based on the precipitation information.

For example, the electronic device for vehicle may identify a sound produced from at least one sound source as a brake friction sound. The electronic device for vehicle according to an embodiment of the disclosure may identify, based on the volume information of the brake friction sound, that the identified brake friction sound corresponds to a distant brake friction sound and corresponds to group 2 of the plurality of preset groups. The electronic device for vehicle according to an embodiment of the disclosure may transmit the distant brake friction sound to the mobile device, when the amount of precipitation is equal to or greater than a set value.

For example, the electronic device for vehicle may identify a sound produced from at least one sound source as a siren sound. The electronic device for vehicle according to an embodiment of the disclosure may identify, based on the volume information of the siren sound, that the identified siren sound corresponds to a distant siren sound and corresponds to group 2 of the plurality of preset groups. The electronic device for vehicle according to an embodiment of the disclosure may transmit the distant siren sound to the mobile device, when the amount of precipitation is equal to or greater than a set value.

The set value may be 15 mm, but is not limited thereto.

The set value may be changed by the user.

The electronic device for vehicle according to an embodiment of the disclosure may obtain surrounding environment information of the vehicle through a sensor.

The surrounding environment information may include brightness information of a road on which the vehicle including the electronic device for vehicle according to an embodiment of the disclosure is driving.

The electronic device for vehicle according to an embodiment of the disclosure may obtain the brightness information of the road in a lux value.

The electronic device for vehicle according to an embodiment of the disclosure may transmit at least one sound included in group 2 to the mobile device, based on the brightness information of the road on which the vehicle is driving.

For example, the electronic device for vehicle may identify a sound produced from at least one sound source as a siren sound. The electronic device for vehicle according to an embodiment of the disclosure may identify, based on the volume information of the siren sound, that the identified siren sound corresponds to a distant siren sound and corresponds to group 2 of the plurality of preset groups. The electronic device for vehicle according to an embodiment of the disclosure may transmit the distant siren sound to the mobile device, when the brightness of the road on which the vehicle including the electronic device for vehicle according to an embodiment of the disclosure is driving is equal to or less than a threshold.

For example, the electronic device for vehicle according to an embodiment of the disclosure may transmit the distant siren sound to the mobile device when the brightness of light obtained through the sensor is equal to or less than 50 lux. However, it is not limited thereto.

The threshold may be changed by the user.

The electronic device for vehicle according to an embodiment of the disclosure may set a transmission condition for transmitting a sound included in group 3 to the mobile device, based on the surrounding environment information of the vehicle.

The electronic device for vehicle according to an embodiment of the disclosure may identify at least one sound with low importance as being included in group 3. The electronic device for vehicle may transmit the at least one sound included in group 3 to the mobile device, based on the surrounding environment information of the vehicle.

For example, the electronic device for vehicle according to an embodiment of the disclosure may identify a sound produced from at least one sound source as a road friction sound. The electronic device for vehicle may identify, based on the volume information of the road friction sound, that the identified road friction sound corresponds to group 3 of the plurality of preset groups. The electronic device for vehicle may transmit the road friction sound to the mobile device, based on location information of a plurality of external vehicles located around the vehicle and approach information of the plurality of external vehicles toward the vehicle. However, it is not limited thereto.

However, the transmission condition for each of the plurality of preset groups is merely an example and is not limited thereto.

The transmission condition for each of the plurality of preset groups may be changed by the user.

The transmission condition for each of the plurality of preset groups may be stored in the memory of the electronic device for vehicle according to an embodiment of the disclosure.

The electronic device for vehicle according to an embodiment of the disclosure may transmit occurrence information of at least one ambient sound to the mobile device.

The occurrence information of the at least one ambient sound may include information indicating that at least one ambient sound has occurred.

For example, the occurrence information of the at least one ambient sound may include information indicating that a nearby horn sound has occurred, when the electronic device for vehicle according to an embodiment of the disclosure recognizes the nearby horn sound.

For example, the occurrence information of the at least one ambient sound may include information indicating that a distant siren sound has occurred, when the electronic device for vehicle according to an embodiment of the disclosure recognizes the distant siren sound. However, it is not limited thereto.

Upon receiving the occurrence information of the at least one ambient sound, the mobile device may transmit a generated sound corresponding to the occurrence information of the at least one ambient sound to the wearable device.

Accordingly, even when latency occurs in transmitting the at least one ambient sound to the mobile device from the electronic device for vehicle according to an embodiment of the disclosure, the mobile device is able to alert the user who is operating the vehicle by transmitting the generated sound corresponding to the occurrence information of the at least one ambient sound to the wearable device.

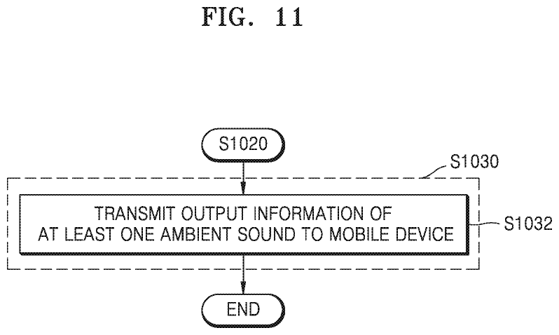

FIG. 11 is a flowchart illustrating an operating method of an electronic device for vehicle according to an embodiment of the disclosure.

Referring to FIG. 11, operations S1020 and S1030 correspond to operations S1020 and S1030 of FIG. 10, respectively.

In operation S1032, the electronic device for vehicle may transmit output information of at least one ambient sound to the mobile device.

The output information may include at least one of volume information of the at least one ambient sound or direction information of at least one sound source that outputs the at least one ambient sound.

For example, the electronic device for vehicle according to an embodiment of the disclosure may transmit, to the mobile device, the direction information of a sound source outputting at least one ambient sound (e.g., located at 170° to the left), when the at least one ambient sound is output from the sound source located at 170° to the left, when it is assumed that the front of the vehicle is 0°.

For example, the electronic device for vehicle according to an embodiment of the disclosure may transmit, to the mobile device, the direction information of a sound source outputting at least one ambient sound (e.g., located at 90° to the right), when the at least one ambient sound is output from the sound source located at 90° to the right, when it is assumed that the front of the vehicle is 0°. However, it is not limited thereto.

For example, the electronic device for vehicle according to an embodiment of the disclosure may recognize that a horn sound has occurred at about 100 dB in a short range. The electronic device for vehicle according to an embodiment of the disclosure may transmit the volume information (about 100 dB) of the nearby horn sound to the mobile device. However, it is not limited thereto.

For example, the electronic device for vehicle according to an embodiment of the disclosure may recognize that the volume of a sound produced from a sound source located in a short range from the vehicle decreases as the distance between the vehicle and the sound source increases (e.g., a case where the volume of the sound decreases from 90 dB to 40 dB). The electronic device for vehicle according to an embodiment of the disclosure may transmit the sound volume change information (indicating that the volume of the sound gradually decreases) to the mobile device.

The mobile device may then transmit, to the wearable device, the sound produced from the sound source such that the sound is output with a gradually decreasing volume. However, it is not limited thereto.

For example, the electronic device for vehicle according to an embodiment of the disclosure may recognize that the volume of a sound produced from a sound source located in a long range from the vehicle increases as the distance between the vehicle and the sound source decreases (e.g., a case where the volume of the sound increases from 30 dB to 60 dB). The electronic device for vehicle according to an embodiment of the disclosure may transmit the sound volume change information (indicating that the volume of the sound gradually increases) to the mobile device.

The mobile device may then transmit, to the wearable device, the sound produced from the sound source such that the sound is output with a gradually increasing volume. However, it is not limited thereto.

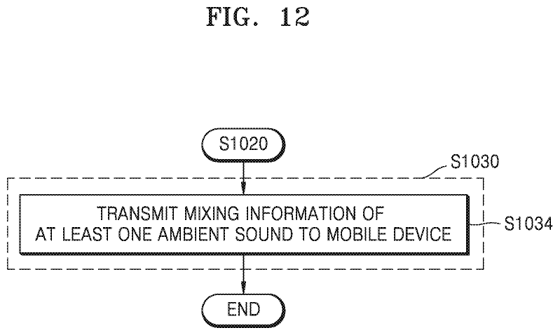

FIG. 12 is a flowchart illustrating an operating method of an electronic device for vehicle according to an embodiment of the disclosure.

Referring to FIG. 12, operations S1020 and S1030 correspond to operations S1020 and S1030 of FIG. 10, respectively.

In operation S1034, the electronic device for vehicle may transmit mixing information of at least one ambient sound to the mobile device.

The mixing information may include information indicating whether to synthesize the at least one ambient sound transmitted to the mobile device with at least one audio data being played on the mobile device.

The audio data may refer to sound output from media being played on the mobile device.

The audio data may include, for example, at least one of music sound or radio sound being played on the mobile device, but is not limited thereto.

In an embodiment of the disclosure, the electronic device for vehicle may transmit, to the mobile device, information indicating that at least one ambient sound and at least one audio data being played on the mobile device are not to be synthesized, when the at least one ambient sound included in group 1 with very high importance is recognized.

In this case, the mobile device may block audio data being played to the wearable device 130, and transmit only the at least one ambient sound.

The electronic device for vehicle according to an embodiment of the disclosure may transmit, to the mobile device, information indicating that at least one ambient sound and at least one audio data being played on the mobile device are not to be synthesized, when the at least one ambient sound included in group 3 with low importance is recognized.

In this case, the mobile device may transmit the audio data being played to the wearable device, and may not transmit the at least one ambient sound.

The electronic device for vehicle according to an embodiment of the disclosure may transmit, to the mobile device, information indicating that at least one ambient sound and at least one audio data being played on the mobile device are to be synthesized, when the at least one ambient sound included in group 2 with high importance is recognized.

In this case, the mobile device may transmit, to the wearable device, a sound resulting from synthesizing the at least one ambient sound with the audio data.

The electronic device for vehicle according to an embodiment of the disclosure may transmit, to the mobile device, at least one ambient sound, output information and mixing information of the at least one ambient sound.

In this case, the mobile device may transmit, to the wearable device, the sound resulting from synthesizing the audio data with the ambient sound or the at least one ambient sound, based on the output information and mixing information of the at least one ambient sound.

For example, based on the output information and mixing information of the at least one ambient sound, the mobile device may receive information indicating that the at least one ambient sound is recognized with a volume of less than 40 dB from the left of the vehicle, and that the at least one ambient sound is to be synthesized with the audio data. The mobile device may synthesize the at least one ambient sound with the audio data being played, at a lower volume than of the audio data. The mobile device may transmit the synthesized sound to the wearable device worn on the left ear such that the synthesized sound is output from the wearable device.

For example, based on the output information and mixing information of the at least one ambient sound, the mobile device may receive information indicating that the at least one ambient sound is recognized with a volume of 40 dB or more and less than 90 dB from the right of the vehicle, and that the at least one ambient sound is to be synthesized with the audio data. The mobile device may synthesize the at least one ambient sound with the audio data being played, at a higher volume than of the audio data. The mobile device may transmit the synthesized sound to the wearable device worn on the right ear such that the synthesized sound is output from the wearable device.

For example, based on the output information and mixing information of the at least one ambient sound, the mobile device may receive mixing information indicating that the at least one ambient sound is recognized with a volume of 90 dB or more from the right of the vehicle, and that the at least one ambient sound is not to be synthesized with the audio data being played. The mobile device may transmit at least one ambient sound to the wearable device worn on the right ear such that only the at least one ambient sound is output at a large volume from the wearable device. However, it is not limited thereto.

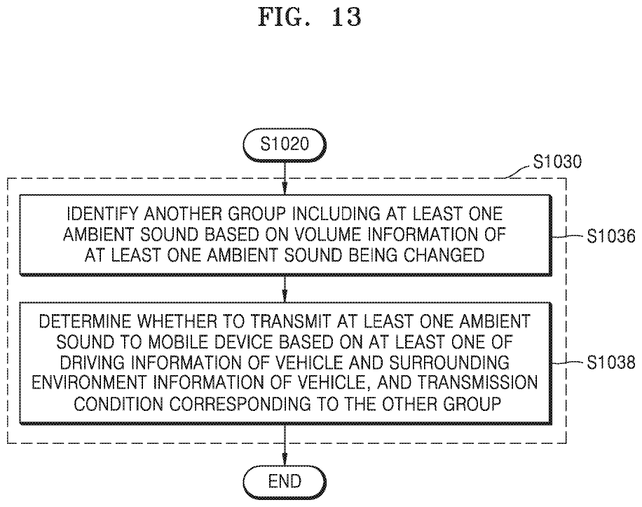

FIG. 13 is a flowchart illustrating an operating method of an electronic device for vehicle according to an embodiment of the disclosure.

Referring to FIG. 13, operations S1020 and S1030 correspond to operations S1020 and S1030 of FIG. 10, respectively.

In operation S1036, the electronic device for vehicle may identify another group that includes at least one ambient sound, based on a change in volume information of the at least one ambient sound.

In an embodiment of the disclosure, the electronic device for vehicle may predict a distance between the vehicle and the sound source based on the volume information of the at least one ambient sound produced from the at least one sound source.

The electronic device for vehicle according to an embodiment of the disclosure may determine that the distance between the vehicle and the sound source that outputs the at least one ambient sound increases, when the volume of the at least one ambient sound decreases.

For example, the electronic device for vehicle according to an embodiment of the disclosure may determine that the distance between the vehicle and a sound source that outputs a siren sound has decreased and then increased, when the volume of the siren sound has increased and then decreased.

For example, the electronic device for vehicle according to an embodiment of the disclosure may determine that the distance between the vehicle and a sound source that outputs a siren sound increases, when recognizing a change in volume of the siren sound from 90 dB to 50 dB. However, it is not limited thereto.

The electronic device for vehicle according to an embodiment of the disclosure may determine that the distance between the vehicle and the sound source that outputs the at least one ambient sound decreases, when the volume of the at least one ambient sound increases.

For example, the electronic device for vehicle according to an embodiment of the disclosure may determine that the distance between the vehicle and a sound source that outputs a horn sound has increased and then decreased, when the volume of the horn sound has decreased and then increased.

For example, the electronic device for vehicle according to an embodiment of the disclosure may determine that the distance between the vehicle and a sound source that outputs a horn sound decreases, when recognizing a change in volume of the horn sound from 40 dB to 100 dB. However, it is not limited thereto.

The electronic device for vehicle according to an embodiment of the disclosure may identify a group that includes the at least one ambient sound among a plurality of preset groups, based on volume information of the at least one ambient sound.

The electronic device for vehicle according to an embodiment of the disclosure may identify a group that includes the at least one ambient sound among a plurality of preset groups, based on a change in volume of the at least one ambient sound being recognized.

For example, the electronic device for vehicle according to an embodiment of the disclosure may recognize a nearby horn sound based on the volume information and type information of the at least one ambient sound. The electronic device for vehicle according to an embodiment of the disclosure may identify the at least one ambient sound identified as the nearby horn sound as being included in group 1.

The electronic device for vehicle according to an embodiment of the disclosure may recognize a change in volume information of the horn sound. The electronic device for vehicle according to an embodiment of the disclosure may recognize the nearby horn sound having changed to a distant horn sound. The electronic device for vehicle according to an embodiment of the disclosure may identify at least one ambient sound identified as a distant horn sound as being included in group 2. However, it is not limited thereto.

For example, the electronic device for vehicle according to an embodiment of the disclosure may recognize a distant brake friction sound based on the volume information and type information of the at least one ambient sound. The electronic device for vehicle according to an embodiment of the disclosure may identify at least one ambient sound identified as a distant brake friction sound as being included in group 2.

The electronic device for vehicle according to an embodiment of the disclosure may recognize a change in volume information of the brake friction sound. For example, the electronic device for vehicle according to an embodiment of the disclosure may recognize that the distant brake friction sound has changed to a nearby brake friction sound. The electronic device for vehicle according to an embodiment of the disclosure may identify the at least one ambient sound identified as the nearby brake friction sound as being included in group 1. However, it is not limited thereto.

In operation S1038, the electronic device for vehicle may determine whether to transmit the at least one ambient sound to the mobile device, based on at least one of driving information of the vehicle and surrounding environment information of the vehicle, and a transmission condition corresponding to another group.

The electronic device for vehicle according to an embodiment of the disclosure may determine whether to transmit the at least one ambient sound to the mobile device, based on at least one of the driving information of the vehicle and the surrounding environment information of the vehicle, and the transmission condition corresponding to the changed group when the volume of the at least one ambient sound is changed and the group including the at least one changed ambient sound is changed.

The electronic device for vehicle according to an embodiment of the disclosure may determine whether to continue to transmit, to the mobile device, the at least one ambient sound that has been being transmitted, when recognizing a change in volume information of the at least one ambient sound after the at least one ambient sound is transmitted to the mobile device.

The electronic device for vehicle according to an embodiment of the disclosure may determine whether to transmit, to the mobile device, the at least one ambient sound whose volume has changed to be lower, based on at least one of the driving information of the vehicle and the surrounding environment information of the vehicle, and the transmission condition corresponding to group 2, when the volume of the at least one ambient sound being transmitted to the mobile device is changed to be lower and the group including the at least one ambient sound is changed from group 1 to group 2. However, it is not limited thereto.

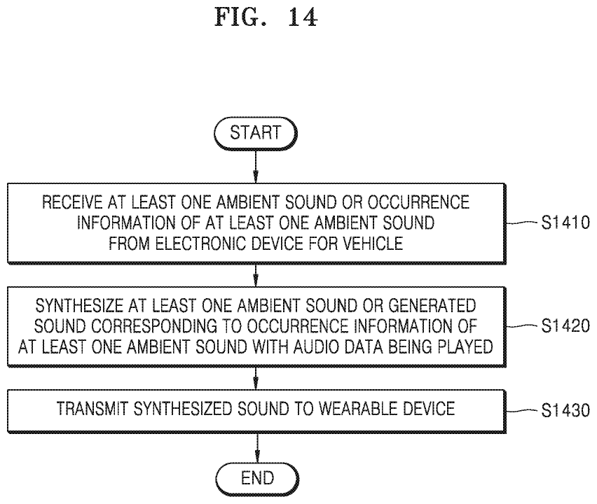

FIG. 14 is a flowchart illustrating an operating method of a mobile device according to an embodiment of the disclosure.

Referring to FIG. 14, in an embodiment of the disclosure, the mobile device and the electronic device for vehicle may be connected through wireless communication.

The mobile device according to an embodiment of the disclosure may be connected to the wearable device through wireless communication.

The wireless connection may involve at least one short-range communication module for performing communication according to a communication standard, such as Bluetooth, Wi-Fi, Bluetooth low energy (BLE), NFC/RFID, Wi-Fi direct, UWB or ZIGBEE, and a long-range communication module for performing communication with a server for supporting the long-range communication according to a long-range communication standard. The long-range communication module may perform communication over a communication network that conforms to 3G, 4G and/or 5G communication standards, or over a network for Internet communication.

In operation S1410, the mobile device may receive at least one ambient sound or occurrence information of the at least one ambient sound from the electronic device for vehicle.

The occurrence information of the at least one ambient sound may include information indicating that at least one ambient sound has occurred.

For example, the occurrence information of the at least one ambient sound may include information indicating that a nearby horn sound has occurred, when the electronic device for vehicle recognizes the nearby horn sound.

For example, the occurrence information of the at least one ambient sound may include information indicating that a distant siren sound has occurred, when the electronic device for vehicle recognizes the distant siren sound. However, it is not limited thereto.

In operation S1420, the mobile device may synthesize the at least one ambient sound or a generated sound corresponding to the occurrence information of the at least one ambient sound with audio data being played.

The audio data may refer to sound output from media being played on the mobile device.

The audio data may include, for example, at least one of music sound or radio sound being played on the mobile device, but is not limited thereto.

The mobile device according to an embodiment of the disclosure may generate a generated sound corresponding to the occurrence information of the at least one ambient sound, based on an artificial intelligence model.

The mobile device according to an embodiment of the disclosure may store the generated sound corresponding to the occurrence information of the at least one ambient sound in the memory of the mobile device.

The generated sound corresponding to the occurrence information of the at least one ambient sound may refer to a nearby horn sound stored in memory or created in the mobile device according to an embodiment of the disclosure based on an artificial intelligence model, when the occurrence information of the at least one ambient sound includes information indicating that the nearby horn sound has occurred. However, it is not limited thereto.

The generated sound corresponding to the occurrence information of the at least one ambient sound may refer to a distant siren sound stored in memory or created in the mobile device according to an embodiment of the disclosure based on an artificial intelligence model, when the occurrence information of the at least one ambient sound includes information indicating that the distant siren sound has occurred. However, it is not limited thereto.

In operation S1430, the mobile device may transmit the synthesized sound to the wearable device.

Accordingly, even when latency occurs in receiving the at least one ambient sound from the electronic device for vehicle according to an embodiment of the disclosure, the mobile device according to an embodiment of the disclosure is able to alert the user who is operating the vehicle by transmitting the generated sound corresponding to the occurrence information of the at least one ambient sound to the wearable device.

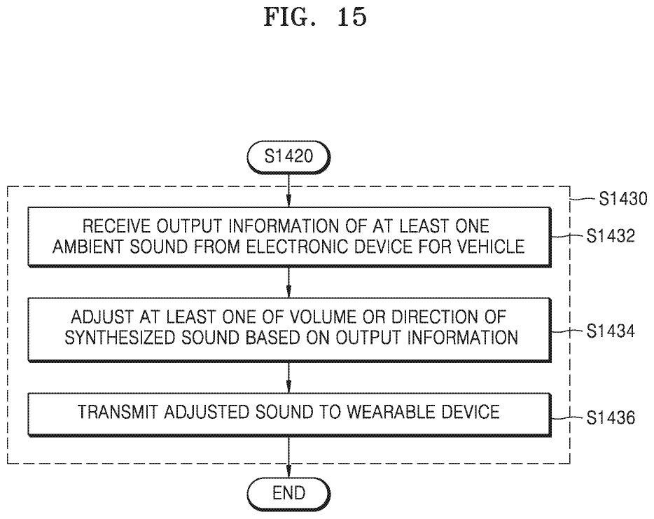

FIG. 15 is a flowchart illustrating an operating method of a mobile device according to an embodiment of the disclosure.

Referring to FIG. 15, operations S1420 and S1430 correspond to operations S1420 and S1430 of FIG. 14, respectively.

In operation S1432, the mobile device may receive output information of at least one ambient sound from the electronic device for vehicle.

The output information may include at least one of volume information of the at least one ambient sound or direction information of at least one sound source that outputs the at least one ambient sound.

For example, the mobile device according to an embodiment of the disclosure may receive, from the electronic device for vehicle, the direction information of a sound source outputting at least one ambient sound (e.g., located at 170° to the left), when the at least one ambient sound is output from the sound source located at 170° to the left, when it is assumed that the front of the vehicle is 0°.

For example, the mobile device according to an embodiment of the disclosure may receive, from the electronic device for vehicle, the direction information of a sound source outputting at least one ambient sound (e.g., located at 90° to the right), when the at least one ambient sound is output from the sound source located at 90° to the right, when it is assumed that the front of the vehicle is 0°. However, it is not limited thereto.

For example, the mobile device according to an embodiment of the disclosure may receive volume information (about 100 dB) of a nearby horn sound from the electronic device for vehicle, when the electronic device for vehicle recognizes that the horn sound has occurred at about 100 dB in a short range. However, it is not limited thereto.

In operation S1434, the mobile device may adjust at least one of the volume or direction of the synthesized sound based on the output information.

For example, the mobile device according to an embodiment of the disclosure may receive, from the electronic device for vehicle, output information indicating that at least one sound source outputting at least one ambient sound is located on the right of the vehicle. The mobile device according to an embodiment of the disclosure may adjust the direction of at least one synthesized sound such that at least one ambient sound is output from the wearable device worn on the right ear. However, it is not limited thereto.

For example, the mobile device according to an embodiment of the disclosure may receive, from the electronic device for vehicle, output information indicating that at least one sound source outputting at least one ambient sound is located on the left of the vehicle and the volume of the at least one ambient sound is 100 dB. The mobile device according to an embodiment of the disclosure may adjust the volume and direction of at least one synthesized sound such that at least one ambient sound is output from the wearable device worn on the left ear at a higher volume than of the audio data being output.

For example, the mobile device according to an embodiment of the disclosure may receive, from the electronic device for vehicle, output information indicating that at least one sound source outputting at least one ambient sound is located on the right of the vehicle and that the volume of the at least one ambient sound is 40 dB. The mobile device according to an embodiment of the disclosure may adjust the direction and volume of at least one synthesized sound such that at least one ambient sound is output from the wearable device worn on the right ear at a lower volume than of the audio data being output. However, it is not limited thereto.

For example, the mobile device according to an embodiment of the disclosure may receive, from the electronic device for vehicle, sound volume change information indicating that the volume of a sound produced from a sound source located in a short range from the vehicle decreases (e.g., the volume of the sound decreases from 90 dB to 40 dB) as the distance between the vehicle and the sound source increases.

In this case, the mobile device according to an embodiment of the disclosure may adjust the sound produced from the sound source to be output with a gradually decreasing volume to the wearable device. However, it is not limited thereto.

For example, the mobile device according to an embodiment of the disclosure may receive, from the electronic device for vehicle, sound volume change information (indicating that the volume of the sound gradually increases) indicating that the volume of a sound produced from a sound source located in a long range from the vehicle increases (e.g., the volume of the sound increases from 30 dB to 60 dB) as the distance between the vehicle and the sound source decreases.

In this case, the mobile device according to an embodiment of the disclosure may adjust the volume of at least one synthesized sound to be output with a gradually increasing volume to the wearable device. However, it is not limited thereto.

In operation S1436, the mobile device may transmit the adjusted sound to the wearable device.

According to an embodiment of the disclosure, an electronic device for vehicle may include at least one microphone, memory storing at least one instruction, a communicator configured to perform communication with a mobile device, and at least one processor configured to execute the at least one instruction stored in the memory.

The at least one processor may be configured to execute the at least one instruction to obtain at least one ambient sound through the at least one microphone.

The at least one processor may be configured to execute the at least one instruction to identify a group including the at least one ambient sound among a plurality of preset groups, based on at least one of type information and volume information of the at least one ambient sound.

The at least one processor may be configured to execute the at least one instruction to control the communicator to transmit the at least one ambient sound to the mobile device, based on at least one of driving information of a vehicle and surrounding environment information of the vehicle, and a transmission condition corresponding to the identified group.

The at least one processor may be configured to execute the at least one instruction to identify the type information of the at least one ambient sound, based on an artificial intelligence model.

The at least one processor may be configured to execute the at least one instruction to control the communicator to transmit, to the mobile device, output information of the at least one ambient sound.

The output information may include at least one of volume information of the at least one ambient sound or direction information of at least one sound source outputting the at least one ambient sound.

The at least one processor may be configured to execute the at least one instruction to control the communicator to transmit mixing information to the mobile device.

The mixing information may include information indicating whether to synthesize the at least one ambient sound transmitted to the mobile device and at least one audio data being played on the mobile device.

The at least one processor may be configured to execute the at least one instruction to identify another group that includes the at least one ambient sound, based on the volume information of the at least one ambient sound being changed.

The at least one processor may be configured to execute the at least one instruction to determine whether to transmit the at least one ambient sound to the mobile device, based on at least one of the driving information of the vehicle and the surrounding environment information of the vehicle, and a transmission condition corresponding to the other group.

The at least one processor may be configured to execute the at least one instruction to control the communicator to transmit occurrence information of the at least one ambient sound to the mobile device.

The surrounding environment information of the vehicle may include at least one of location information of a sound source that generates the at least one ambient sound, weather information around the vehicle or speed information of an external vehicle located around the vehicle.

The driving information of the vehicle may include at least one of speed information of the vehicle or speed change information of the vehicle.

According to an embodiment of the disclosure, a mobile device may include a communicator configured to perform communication with an electronic device for vehicle and a wearable device, memory storing at least one instruction, and at least one processor configured to execute the at least one instruction stored in the memory.

The at least one processor may be configured to execute the at least one instruction to control the communicator to receive, from the electronic device for vehicle, at least one ambient sound or occurrence information of the at least one ambient sound.

The at least one processor may be configured to execute the at least one instruction to synthesize the at least one ambient sound or a generated sound corresponding to the occurrence information of the at least one ambient sound with audio data being played.

The at least one processor may be configured to execute the at least one instruction to control the communicator to transmit the synthesized sound to the wearable device.

The at least one processor may be configured to execute the at least one instruction to control the communicator to receive, from the electronic device for vehicle, output information of the at least one ambient sound.

The at least one processor may be configured to execute the at least one instruction to control the communicator to transmit, to the wearable device, the at least one ambient sound, based on the output information.

The output information may include at least one of volume information of the at least one ambient sound or direction information of at least one sound source outputting the at least one ambient sound.

The at least one processor may be configured to execute the at least one instruction to control the communicator to receive, from the electronic device for vehicle, output information including at least one of volume information of the at least one ambient sound or direction information of at least one sound source outputting the at least one ambient sound.

The at least one processor may be configured to execute the at least one instruction to adjust at least one of volume or direction of the synthesized sound, based on the output information.

The at least one processor may be configured to execute the at least one instruction to control the communicator to transmit the adjusted sound to the wearable device.

According to an embodiment of the disclosure, an operating method of an electronic device for vehicle may include obtaining at least one ambient sound through at least one microphone.

According to an embodiment of the disclosure, the operating method of the electronic device for vehicle may include identifying a group including the at least one ambient sound among a plurality of preset groups, based on at least one of type information and volume information of the at least one ambient sound.

According to an embodiment of the disclosure, the operating method of the electronic device for vehicle may include transmitting the at least one ambient sound to the mobile device, based on at least one of driving information of a vehicle and surrounding environment information of the vehicle, and a transmission condition corresponding to the identified group.

According to an embodiment of the disclosure, an operating method of an electronic device for vehicle may include transmitting output information of the at least one ambient sound to the mobile device.

The output information may include at least one of volume information of the at least one ambient sound or direction information of at least one sound source outputting the at least one ambient sound.

According to an embodiment of the disclosure, an operating method of an electronic device for vehicle may include transmitting mixing information to the mobile device.

The mixing information may include information indicating whether to synthesize the at least one ambient sound transmitted to the mobile device with at least one audio data being played on the mobile device.

According to an embodiment of the disclosure, the operating method of the electronic device for vehicle may include identifying another group that includes the at least one ambient sound, based on volume information of the at least one ambient sound being changed.

According to an embodiment of the disclosure, the operating method of the electronic device for vehicle may include determining whether to transmit the at least one ambient sound to the mobile device, based on at least one of driving information of the vehicle and surrounding environment information of the vehicle, and a transmission condition corresponding to the other group.

According to an embodiment of the disclosure, an operating method of an electronic device for vehicle may include transmitting occurrence information of the at least one ambient sound to the mobile device.

According to an embodiment of the disclosure, an operating method of an electronic device for vehicle may include identifying the type information of the at least one ambient sound based on an artificial intelligence model.

The surrounding environment information of the vehicle may include at least one of location information of a sound source that generates the at least one ambient sound, weather information around the vehicle or speed information of an external vehicle located around the vehicle.

According to an embodiment of the disclosure, an operating method of a mobile device may include receiving at least one ambient sound or occurrence information of the at least one ambient sound from an electronic device for vehicle.

According to an embodiment of the disclosure, an operating method of a mobile device may include synthesizing the at least one ambient sound or a generated sound corresponding to the occurrence information of the at least one ambient sound with audio data being played.

According to an embodiment of the disclosure, an operating method of a mobile device may include transmitting the synthesized sound to a wearable device.

According to an embodiment of the disclosure, an operating method of a mobile device may include receiving output information of the at least one ambient sound from the electronic device for vehicle.

According to an embodiment of the disclosure, an operating method of a mobile device may include transmitting the at least one ambient sound to the wearable device.

The output information may include at least one of volume information of the at least one ambient sound or direction information of at least one sound source outputting the at least one ambient sound.

According to an embodiment of the disclosure, an operating method of a mobile device may include receiving, from the electronic device for vehicle, output information including at least one of volume information of the at least one ambient sound or direction information of at least one sound source outputting the at least one ambient sound.

According to an embodiment of the disclosure, an operating method of a mobile device may include adjusting at least one of volume or direction of the synthesized sound, based on the output information.

According to an embodiment of the disclosure, an operating method of a mobile device may include transmitting the adjusted sound to the wearable device.

According to an embodiment of the disclosure, an operating method of at least one of an electronic device for vehicle or a mobile device may be implemented in the form of program instructions which are executable by various computing means and recorded in computer-readable media. The computer-readable medium may include program instructions, data files, data structures, or the like, separately or in combination. The program instructions recorded on the medium may be designed and configured specially for the disclosure, or may be well-known to those of ordinary skill in the art of computer software. Examples of the computer readable recording medium include magnetic medium, such as hard disk, floppy disk and magnetic tape, optical medium, such as compact disc read-only memory (CD-ROM) and digital versatile disc (DVD), magneto-optical medium, such as floptical disk, and hardware device specially configured to store and perform program instructions, such as read-only memory (ROM), random-access memory (RAM), flash memory, or the like. Examples of the program instructions include not only machine language codes but also high-level language codes which are executable by various computing means using an interpreter.

Furthermore, an operating method of at least one of the electronic device for vehicle or the mobile device according to the disclosed embodiments may be included and provided in a computer program product. The computer program product may be a commercial product that may be traded between a seller and a buyer.

The computer program product may include a software program and a computer-readable storage medium having the software program stored thereon. For example, the computer program product may include a product in the form of a software program that is electronically distributed by the manufacturer of the electronic device or by an electronic market (e.g., Google play store®, or App store®). For the electronic distribution, at least a portion of the software program may be stored in a storage medium or arbitrarily created. In this case, the storage medium may be one of a server of the manufacturer or of a relay server that temporarily stores the software program.

In a system including a server and a client device, the computer program product may include a storage medium of the server or a storage medium of the client device. Alternatively, when there is a third device (e.g., a smart phone) communicatively connected to the server or the client device, the computer program product may include a storage medium of the third device. In another example, the computer program product may be transferred from the server to the client device or the third device, or may include a software program itself that is transferred from the third device to the client device.

In this case, one of the server, the client device, and the third device may execute the computer program product to perform the method according to the embodiments of the disclosure. Alternatively, two or more of the server, the client device, and the third device may execute the computer program product to perform the method according to the embodiments of the disclosure in a distributed fashion.

For example, the server (e.g., a cloud server or an AI server) may execute the computer program product stored therein to control the client device communicatively connected to the server to perform the method according to the embodiments of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device for a vehicle comprising:
at least one microphone;
memory, comprising one or more storage media, storing instructions;
a communicator configured to perform communication with a mobile device; and
at least one processor communicatively coupled to the at least one microphone, the memory, and the communicator,
wherein the instructions, when executed by the at least one processor individually or collectively, cause the electronic device to:
obtain at least one ambient sound through the at least one microphone,
identify, among a plurality of preset groups, a group including the at least one ambient sound, based on at least one of type information and volume information of the at least one ambient sound, and
control the communicator to transmit the at least one ambient sound to the mobile device, based on at least one of driving information of a vehicle and surrounding environment information of the vehicle, and a transmission condition corresponding to the identified group.

2. The electronic device of claim 1, wherein the instructions, when executed by the at least one processor individually or collectively, further cause the electronic device to identify the type information of the at least one ambient sound, based on an artificial intelligence model.

3. The electronic device of claim 1,
wherein the instructions, when executed by the at least one processor individually or collectively, further cause the electronic device to control the communicator to transmit output information of the at least one ambient sound to the mobile device, and
wherein the output information comprises at least one of volume information of the at least one ambient sound or direction information of at least one sound source outputting the at least one ambient sound.

4. The electronic device of claim 1,
wherein the instructions, when executed by the at least one processor individually or collectively, further cause the electronic device to control the communicator to transmit mixing information to the mobile device, and
wherein the mixing information comprises information indicating whether to synthesize the at least one ambient sound transmitted to the mobile device with at least one audio data being played on the mobile device.

5. The electronic device of claim 1, wherein the instructions, when executed by the at least one processor individually or collectively, further cause the electronic device to:
identify another group including the at least one ambient sound, based on volume information of the at least one ambient sound being changed, and
determine whether to transmit the at least one ambient sound to the mobile device, based on at least one of the driving information of the vehicle and the surrounding environment information of the vehicle, and a transmission condition corresponding to the other group.

6. The electronic device of claim 1, wherein the instructions, when executed by the at least one processor individually or collectively, further cause the electronic device to control the communicator to transmit occurrence information of the at least one ambient sound to the mobile device.

7. The electronic device of claim 1, wherein the surrounding environment information of the vehicle comprises at least one of location information of a sound source generating the at least one ambient sound, weather information around the vehicle, or speed information of an external vehicle located around the vehicle.

8. A method of operating an electronic device for a vehicle, the method comprising:
obtaining at least one ambient sound through at least one microphone;
identifying, among a plurality of preset groups, a group including the at least one ambient sound, based on at least one of type information and volume information of the at least one ambient sound; and
transmitting the at least one ambient sound to a mobile device, based on at least one of driving information of a vehicle and surrounding environment information of the vehicle, and a transmission condition corresponding to the identified group.

9. The method of claim 8, further comprising:
identifying the type information of the at least one ambient sound, based on an artificial intelligence model.

10. The method of claim 8,
wherein the transmitting of the at least one ambient sound to the mobile device comprises transmitting output information of the at least one ambient sound to the mobile device, and
wherein the output information comprises at least one of volume information of the at least one ambient sound or direction information of at least one sound source outputting the at least one ambient sound.

11. The method of claim 8,
wherein the transmitting of the at least one ambient sound to the mobile device comprises transmitting mixing information to the mobile device, and
wherein the mixing information comprises information indicating whether to synthesize the at least one ambient sound transmitted to the mobile device with at least one audio data being played on the mobile device.

12. The method of claim 8, wherein the transmitting of the at least one ambient sound to the mobile device comprises:
identifying another group including the at least one ambient sound, based on volume information of the at least one ambient sound being changed; and
determining whether to transmit the at least one ambient sound to the mobile device, based on at least one of the driving information of the vehicle and the surrounding environment information of the vehicle, and a transmission condition corresponding to the other group.

13. The method of claim 8, further comprising:
transmitting occurrence information of the at least one ambient sound to the mobile device.

14. The method of claim 8, wherein the surrounding environment information of the vehicle comprises at least one of location information of a sound source generating the at least one ambient sound, weather information around the vehicle or speed information of an external vehicle located around the vehicle.

15. One or more non-transitory computer-readable storage media storing one or more computer programs including computer-executable instructions that, when executed by at least one processor of an electronic device for a vehicle individually or collectively, cause the electronic device to perform operations, the operations comprising:
obtaining at least one ambient sound through at least one microphone;
identifying, among a plurality of preset groups, a group including the at least one ambient sound, based on at least one of type information and volume information of the at least one ambient sound; and
transmitting the at least one ambient sound to a mobile device, based on at least one of driving information of a vehicle and surrounding environment information of the vehicle, and a transmission condition corresponding to the identified group.

16. The one or more non-transitory computer-readable storage media of claim 15, the operations further comprising:
identifying the type information of the at least one ambient sound, based on an artificial intelligence model.

17. The one or more non-transitory computer-readable storage media of claim 15, the operations further comprising:
transmitting output information of the at least one ambient sound to the mobile device,
wherein the output information comprises at least one of volume information of the at least one ambient sound or direction information of at least one sound source outputting the at least one ambient sound.

18. The one or more non-transitory computer-readable storage media of claim 15,
wherein the transmitting of the at least one ambient sound to the mobile device comprises transmitting mixing information to the mobile device, and
wherein the mixing information comprises information indicating whether to synthesize the at least one ambient sound transmitted to the mobile device with at least one audio data being played on the mobile device.

19. The one or more non-transitory computer-readable storage media of claim 15, the operations further comprising:
identifying another group including the at least one ambient sound, based on volume information of the at least one ambient sound being changed; and
determining whether to transmit the at least one ambient sound to the mobile device, based on at least one of the driving information of the vehicle and the surrounding environment information of the vehicle, and a transmission condition corresponding to the other group.

20. The one or more non-transitory computer-readable storage media of claim 15, the operations further comprising:
transmitting occurrence information of the at least one ambient sound to the mobile device.
